(19) United States
(12) Patent Application Publication
(10) Pub. No.: US 2016/0232487 A1
(43) Pub. Date: Aug. 11, 2016

(54) Package Delivery System, Service, Method and Application

(71) Applicant: Ben Yonker, New York, NY (US)

(72) Inventor: Ben Yonker, New York, NY (US)

(21) Appl. No.: 14/619,311

(22) Filed: Feb. 11, 2015

(51) Int. Cl. G06Q 10/08; G06Q 20/42; H04L 29/08; G06Q 20/38

(52) U.S. Cl. CPC G06Q 10/0834; G06Q 20/38; G06Q 20/42; G06Q 10/0835; H04L 67/18; H04L 67/10

(57) ABSTRACT

A system, service, method, and application to facilitate at least one Package delivery from at least one location to at least one other location.

### FIELD OF INVENTION

The present invention is in the field of messenger delivery services, more particularly, the field of package retrieval, transport, and delivery initiated by the use of an electronic interface between users and service providers.

### SUMMARY OF INVENTION

In the present embodiment, in its most reduced and simplest form, the invention is a program or series of programs residing on at least one computer that enables a person to have a Package picked up at one location and delivered to another location. There may be actions and/or added services between the pick up and drop off of the Package, and the process can expand in complexity to multiple Packages picked up from multiple locations, to be dropped off at multiple locations, with each Package requiring individualized processing or actions prior to drop off. The invention works in conjunction with an infrastructure involving in its most basic form a user or customer with a Package that needs to be delivered from one place to another, a courier who will pick up and deliver the Package, and a central company that each communicates with. In a shorthand notation, these components will reduce to the company component or Company, user component or Customer user, courier component or Courier, and everyone, which comprises Company, Customer user, and Courier.

More specifically, from the point of view of the Company and at least one Customer user and at least one Courier, the invention is an application and/or program for communicating and interacting with human and/or machine components involved in at least one Package retrieval, transport, and delivery that can comprise at least one of the following steps: Downloading app from a company to a user and/or initiate an app or initiate an application from a web-based program and/or from a website (download app and/or initiate app or initiate application from web-based program 10); register and/or Sign-in to at least one of an application, web-based program, website, and/or other means 11; Service Request 12; Schedule at least one pick-up time 13; Schedule at least one delivery time 14; select at least one Courier service type 15; specify at least one Package contents 16; specification and/or special work description of at least one intermediate operation 17; confirmation of data input 18; choosing method of payment 19; payment confirmation 20; specifying notification 21; Company and Notification Parties receives confirmation of order 22;

and from the Company's interface with at least one Customer user and/or at least one Courier: receiving Service Request 30; reformatting Service Request to fit at least one template 31; devising at least one Package delivery fulfillment strategy 32; Fulfillment Request submitted by a Dispatcher to at least one Courier 33 within an area who can potentially fulfill said Fulfillment Request in whole or in part; response of at least one Courier 34; awarding the assignment for order fulfillment or a part thereof to at least one Courier 35; transportation fulfillment 36; closing out transaction upon at least one Package delivery 37; billing Authorized payer when required 38, and funds are then released to Company unless prepaid and/or on open account;

and from the Customer user's interface with the Company and/or at least one Courier: downloading app and/or initiate or initiate application from web-based program 40 or website from the Company, Register and/or Sign-in to at least one of an application, web-based program, website, and/or other means 41, Entering Service Request 42, Scheduling at least one pick-up time 43, Scheduling at least one delivery time 44, selecting at least one Courier service type 45, specifying at least one Package contents 46, specification and/or special work description of at least one intermediate operation 47, confirmation of data input before this step 48, choosing method of payment 49, payment confirmation 50, specifying notification 51, notification Parties receives confirmation 52 of order in specified methods of notification, at least one Courier arrives at at least one Sender's Pick-up location at at least one designated time 53, at least one Courier arrives at at least one Receiver's Drop-off location at at least one designated time 54, at least one Notification received by Notification Parties 55, billing Authorized payer when required 56, and funds are then released to Company unless prepaid and/or on open account;

and from at least one Courier's interface with the Company and/or at least one Customer user: Fulfillment Request received from a Dispatcher by at least one Courier 60, Fulfillment Request in whole or in part accepted 61, Fulfillment Request assigned as a Job including disseminating instructions and supporting material and/or documentation 62, fulfillment of Job 63, closing out transaction upon at least one Package delivery 64.

The step to register and/or Sign-in to at least one of an application, web-based program, website, and/or other means 11 can comprise at least one of the following steps: filling in at least one profile data field, sign-in by entering at least one of: user name, password, at least one other sign-in request or requirement with or without auto fill and/or add to at least one menu which can be a drop down menu or other menu display.

The Service Request 12 step can comprise at least one of the following steps: entering Order Placer information, entering pick-up information, and entering at least one drop-off and/or Receiver information.

Order Placer information entry can comprise at least one of the following: entering name or selecting from at least one menu with or without auto fill and/or adding to at least one menu; entering at least one e-mail address and/or selecting from at least one menu with or without auto fill and/or adding to at least one menu; entering at least one phone number and/or selecting from at least one menu with or without auto fill and/or adding to at least one menu; entering other information that is at least one of screen name, additional phone number, additional e-mail address, customer code and/or account, other information that may be requested or required, and/or selecting from at least one menu with or without auto fill and/or adding to at least one menu; entering at least one amount of insurance necessary; and/or deleting at least one pre-existing data from at least one at least one menu.

Pick-up information entry can comprise at least one of the following: entering at least one Authorized Person's name and/or selecting from at least one menu with or without auto fill and/or adding to at least one menu; entering at least one Sender and/or Pick-up location and/or selecting from at least one menu with or without auto fill and/or adding to at least one menu; enabling or disabling at least one Geo-location; entering at least one Sender and/or pick-up e-mail address and/or selecting from at least one menu with or without auto fill and/or adding to at least one menu; entering at least one pick-up phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement; entering at least one third Party acceptability; and/or deleting at least one pre-existing data from at least one at least one menu.

Entering at least one drop-off and/or Receiver information can comprise at least one of the following: entering at least one Authorized Person's name and/or selecting from at least one menu with or without auto fill and/or adding to at least one menu; entering at least one Receiver and/or Drop-off location and/or selecting from at least one menu with or without auto fill and/or adding to at least one menu; enabling or disabling at least one Geo-location; entering at least one Receiver and/or drop-off e-mail address and/or selecting from at least one menu with or without auto fill and/or adding to at least one menu; entering at least one Receiver and/or drop-off phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement and who is at least one Authorized Person to sign for at least one Package and/or selecting from at least one menu with or without auto fill and/or adding to at least one menu; entering at least one third Party acceptability to accept Package; and/or deleting at least one pre-existing data from at least one at least one menu.

The step to schedule at least one pick-up time 13 can comprise specification of at least one of the following: choosing at least one time; choosing at least one level of urgency that comprises immediately and/or at least one delivery window of tolerance.

The step to schedule at least one delivery time 14 can comprise specification of at least one of the following: choosing at least one time, and/or choosing at least one level of urgency that comprises immediately and/or at least one delivery window of tolerance.

The step to select at least one Courier service type 15 can comprise at least one of: selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting at least one previously stored selection; selecting at least one outside services employed using at least one of Fed Ex, UPS, US mail, Parcel post, other delivery service, don't care, selecting at least one previously stored selection and provide necessary information so the outside service can be invoked; and/or deleting at least one pre-existing data from at least one at least one menu.

The step of specify at least one Package contents 16 can comprise at least one of the following attributes: at least one of liquid, solid, biological, living, animal, plant, chemical; at least one of toxicity, explosive, dusty, foul and/or strange aroma; at least one Package size; at least one approximate weight; at least one of at least one Package fragility, orientation to the vertical, specifying special handling instructions and/or free form notes, selecting at least one previously stored selection; at least one other requested or required attribute and/or other data; and/or deleting at least one pre-existing data from at least one at least one menu.

The step of specification and/or special work description of at least one intermediate operation 17 can include but is not limited to Xeroxing, binding, collating, addressing, packaging, other clerical functions, filing papers in court, paying fees, getting filing receipts, and taking any at least one other action necessary to effect delivery of at least one Package.

The step of confirmation of data input 18 before this step can comprise one of the choices: yes, which can equal an official submission of order then continue to method of payment; or no, which can require a need to re-enter data and have confirmation of data re-entry.

The step of choosing method of payment 19 can be at least one of the following: pre-paid; open account; credit card; Paypal and/or other money on line services that can withdraw money directly from at least one of credit cards, debit cards, bank accounts; wire transfer; electronic transfer directly from bank account.

The step of payment confirmation 20 can be at least one of the following choices: yes, and continue to next step; or no, and make another arrangement and return to method of payment.

The step of specifying notification 21 can include at least one of: specification of all Notification Parties Receiver confirmation of order is to be sent, which can comprise at least one of at least one Order Placer, Sender, Receiver, at least one new customer and/or company, Authorized Person; and confirmation of order for all Notification Parties to be notified in at least one of the following selectable methods of notification: e-mail, text, phone and/or voice message, electronic data transmission, social network, internet, intranet, Ethernet, smart device transmission and or reception.

The step of company and Notification Parties receives confirmation of order 22 in all specified methods of notification.

The step of receiving Service Request 30 can be via at least one of the web or a website, an app, e-mail, text, phone call and/or voice message, social media, instant message, encrypted or unencrypted instructions received in storage medium of any kind.

The step of devising at least one Package delivery fulfillment strategy 32 can include at least one of: a short-distance delivery model that can comprise the same Courier picking up at least one Package at at least one Pick-up location and dropping off at least one Package at at least one Drop-off location employing walking and one other form of motorized or non-motorized transportation; a mid-distance delivery model that can comprise the same Courier picking up at least one Package at at least one Pick-up location and dropping off at least one Package at at least one Drop-off location employing walking and multiple forms of motorized and/or non-motorized transportation which may or may not include public transportation; a long-distance delivery model that can comprise the same or more than one Courier to provide Job fulfillment employing at least two of the following: walking, at least one form of motorized and/or non-motorized transportation, at least one type of public transportation, at least one carrier such as including but not limited to Fed Ex, UPS, US mail, Parcel post, other delivery service; invoking and/or performing at least one intermediate operation that can include but is not limited to Xeroxing, binding, collating, addressing, packaging, other clerical functions, filing papers in court, paying fees, getting filing receipts, and taking any at least one other action necessary to effect delivery of at least one Package; and/or performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, and/or taking any other action necessary.

The step of response of at least one Courier 34 can be via at least one means providing at least one of including but not limited to name and/or identifying information, location, availability, at least one method of transportation available, at least one skill set necessary to perform said at least one intermediate operation.

The step of awarding the assignment for order fulfillment or a part thereof to at least one Courier 35, wherein the decision of which Courier is awarded the assignment for order fulfillment or a part thereof can be made using at least one of the following criteria: first to respond, physical strength or other physical attribute, previous experience with special handling conditions of the type of Package to be delivered, mechanical aptitude, technical expertise, language skills, intelligence, professional demeanor, personal hygiene, reliability and/or punctuality, speed necessity of order fulfillment, mental health history, academic achievement, law enforcement experience, legal experience, military experience, special occupational experience, special licenses including but not limited to automobile, truck, motorcycle, boat, pilot, firearms, notary public in at least one state, at least one other criteria.

The step of transportation fulfillment 36 wherein at least one of the following can occur: at least one Courier takes custody of at least one Package at at least one Pick-up location, transports at least one Package to at least one Transfer location, picks up at least one Package from at least one Transfer location, delivers at least one Package to at least one Drop-off location, and/or maintains at least one Chain of custody.

The step of closing out transaction upon at least one Package delivery 37 can include at least one of the following: delivery of at least one Package to at least one Drop-off location; securing at least one signature of at least one Authorized Person to confirm at least one Chain of custody proof; at least one Courier notification can be made to the Company informing that at least one Package has been delivered to at least one Drop-off location; company can notify Notification Parties by at least one selected method of notification including but not limited to: e-mail, text, phone and/or voice message, electronic data transmission, social network, internet, intranet, Ethernet, smart device transmission and or reception. This notification may include at least one signature of at least one Authorized Person who signed for at least one Package at at least one Drop-off location.

The step of register and/or sign-in to at least one of an application, web-based program, website, and/or other means 41 can comprise at least one of the following steps: filling in at least one profile data field and/or sign-in by entering at least one of: user name, password, at least one other sign-in request or requirement with or without auto fill and/or adding to at least one menu;

The step of entering Service Request 42 can comprise at least one of the following steps: entering Order Placer information, entering at least one Pick-up and/or Sender set of information, and/or entering at least one drop-off and/or Receiver set of information.

Entering Order Placer information can comprise at least one of the following: entering name or selecting from at least one menu with or without auto fill and/or adding to at least one menu; entering at least one e-mail address and/or selecting from at least one menu with or without auto fill and/or adding to at least one menu; entering at least one phone number and/or selecting from at least one menu with or without auto fill and/or adding to at least one menu;

entering other information that is at least one of screen name, additional phone number, additional e-mail address, customer code or account, other information that may be requested or required, and/or selecting from at least one menu with or without auto fill and/or adding to at least one menu; entering at least one amount of insurance necessary; and/or deleting at least one pre-existing data from at least one at least one menu.

Entering at least one pick-up and/or Sender set of information can comprise at least one of the following: entering at least one Authorized Person's name and/or selecting from at least one menu with or without auto fill and/or adding to at least one menu; entering at least one Sender and/or Pick-up location and/or selecting from at least one menu with or without auto fill and/or adding to at least one menu; enabling or disabling at least one Geo-location; entering at least one pick-up and/or Sender e-mail address and/or selecting from at least one menu with or without auto fill and/or adding to at least one menu; entering at least one pick-up and/or Sender phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement; entering at least one third Party acceptability; and/or deleting at least one pre-existing data from at least one at least one menu.

Entering at least one drop-off and/or Receiver set of information can comprise at least one of the following: entering at least one Authorized Person's name and/or selecting from at least one menu with or without auto fill and/or adding to at least one menu; entering at least one Receiver and/or Drop-off location and/or selecting from at least one menu with or without auto fill and/or adding to at least one menu; enabling or disabling at least one Geo-location; entering at least one Receiver and/or drop-off e-mail address and/or selecting from at least one menu with or without auto fill and/or adding to at least one menu; entering at least one Receiver and/or drop-off phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement and who is at least one Authorized Person to sign for at least one Package and/or selecting from at least one menu with or without auto fill and/or adding to at least one menu; entering at least one third Party acceptability to accept at least one Package; and/or deleting at least one pre-existing data from at least one at least one menu.

The step of scheduling at least one pick-up time 43 can comprise specification of at least one of the following: choosing at least one time; choosing at least one level of urgency that comprises immediately and/or at least one delivery window of tolerance.

The step of scheduling at least one delivery time 44 can comprise specification of at least one of the following: choosing at least one the time; choosing at least one level of urgency that comprises immediately and/or at least one delivery window of tolerance.

The step of selecting at least one Courier service type 45 can comprise at least one of: selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting previously stored selections; selecting at least one outside services employed using at least one of Fed Ex, UPS, US mail, Parcel post, other delivery service, don't care, selecting at least one previously stored selection and provide necessary information so said outside service can be invoked; and/or deleting at least one pre-existing data from at least one at least one menu.

The step of specifying at least one Package contents 46 can comprise at least one of the following attributes: at least one of liquid, solid, biological, living, animal, plant, chemical; at least one of toxicity, explosive, dusty, foul and/or strange aroma; at least one Package size; at least one approximate weight; at least one of at least one Package fragility, orientation to the vertical, at least one special handling instruction and/or free form notes, selecting at least one previously stored selection; at least one other requested or required attribute and/or other data; and/or deleting at least one pre-existing data from at least one at least one menu.

The step of specification and/or special work description of at least one intermediate operation 47 can include but is not limited to Xeroxing, binding, collating, addressing, packaging, other clerical functions, filing papers in court, paying fees, getting filing receipts, and taking any at least one other action necessary to effect delivery of at least one Package.

The step of confirmation of data input before this step 48 can comprise one of the choices: yes, to signify an official submission of order then continue to method of payment, or no to re-enter data and confirm data re-entry.

The step of choosing method of payment 49 can be at least one of the following: pre-paid; open account; credit card; Paypal and/or other money on line services that can withdraw money directly from at least one of credit cards, debit cards, bank accounts; wire transfer; and/or electronic transfer directly from bank account.

The step of payment confirmation 50 can be at least one of the following choices: yes, and continue to next step; or no, to make another arrangement and return to method of payment. The step of specifying notification 51 can include at least one of: specification of all Notification Parties Receiver confirmation of order is to be sent, which comprises at least one of at least one Order Placer, Sender, Receiver, at least one new customer and/or company, Authorized Person; and/or confirmation of order for all said Notification Parties to be notified in at least one of the following selectable methods of notification: e-mail, text, phone and/or voice message, electronic data transmission, social network, internet, intranet, Ethernet, smart device transmission and or reception.

The step of at least one Courier arrives at at least one Sender's Pick-up location at at least one designated time 53 can require at least one of at least one Authorized Person gives at least one Package to at least one Courier, at least one Authorized Person signs at least one Courier's paperwork, at least one Courier signs at least one Authorized Person's paperwork.

The step of at least one Courier arrives at at least one Receiver's Drop-off location at at least one designated time 54 can require at least one of at least one Authorized Person receives at least one Package from at least one Courier, at least one Authorized Person signs at least one Courier's paperwork, at least one Courier signs at least one Authorized Person's paperwork and/or confirmation or affirmation of at least one other action.

The step of at least one Notification received by Notification Parties 55 by at least one selected method of notification can include but is not limited to: e-mail, text, phone and/or voice message, electronic data transmission, social network, internet, intranet, Ethernet, smart device transmission and or reception.

The step of Fulfillment Request received from a Dispatcher by at least one Courier 60 within an area that can potentially fulfill the Fulfillment Request in whole or in part can do at least one of the following: retrieve at least one Package from at least one Sender at at least one Pick-up location and/or Transfer location; deliver at least one Package to at least one Drop-off location and/or at least one other Transfer location; invoke and/or perform at least one intermediate value added operation including but not limited to Xeroxing, binding, collating, addressing, packaging, other clerical functions, filing papers in court, paying fees, getting filing receipts, and taking any at least one other action necessary; abide by the handling conditions of said Fulfillment Request, perform at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.

The step of Fulfillment Request assigned as a Job including disseminating instructions and supporting material and/or documentation 62 can define at least one of the following functions: retrieving at least one Package from at least one Sender at at least one Pick-up location and/or Transfer location; delivering at least one Package to at least one Drop-off location and/or at least one other Transfer location; invoking and/or performing at least one intermediate value added operation including but not limited to Xeroxing, binding, collating, addressing, packaging, other clerical functions, filing papers in court, paying fees, getting filing receipts, and taking any at least one other action necessary; abiding by the handling conditions of said Job; and/or performing at least one of any other operation and/or function necessary to affect Job fulfillment and communication with the Company and/or at least one Authorized Person to define and/or redefine at least one of including but not limited to progress at at least one step in the fulfillment process, articulating any problems encountered, taking corrective action, affecting damage control, performing any other action necessary.

The step of closing out transaction upon at least one Package delivery 64 can includes at least one of the following: at least one Package delivery to at least one Drop-off location; securing at least one signature of at least one Authorized Person to confirm at least one Chain of custody proof; at least one Authorized Person informing Company that all order fulfillment functions have been successfully performed; and/or at least one Courier notification to Company that at least one Package has been delivered to at least one Drop-off location.

In another embodiment, the invention is a program or series of programs residing on at least one computer that is an application and/or program for communicating and interacting with human and/or machine components as applicable to the Company's interface with at least one Customer user and/or at least one Courier involved in at least one Package retrieval, transport, and delivery comprising at least one of the following steps: receive Service Request 70; reformatting Service Request to fit at least one template 71; devising at least one Package delivery fulfillment strategy 72; Fulfillment Request submitted by a Dispatcher to at least one Courier 73 within an area who can potentially fulfill said Fulfillment Request in whole or in part; response of at least one Courier 74; awarding the assignment for order fulfillment or a part thereof to at least one Courier 75; transportation fulfillment 76; closing out transaction upon at least one Package delivery 77; billing Authorized payer when required 78, and funds are then released to Company unless prepaid and/or on open account.

The step to receiving Service Request 70 can be via at least one of the web or a website, an app, e-mail, text, phone call and/or voice message, social media, instant message, encrypted or unencrypted instructions received in storage medium of any kind;

The step of devising at least one Package delivery fulfillment strategy 72 can include at least one of: a short-distance delivery model that can comprise the same Courier picking up at least one Package at at least one Pick-up location and dropping off at least one Package at at least one Drop-off location employing walking and one other form of motorized or non-motorized transportation; a mid-distance delivery model that can comprise the same Courier picking up at least one Package at at least one Pick-up location and dropping off at least one Package at at least one Drop-off location employing walking and multiple forms of motorized and/or non-motorized transportation which may or may not include public transportation; a long-distance delivery model that can comprise the same or more than one Courier to provide Job fulfillment employing at least two of the following: walking, at least one form of motorized and/or non-motorized transportation, at least one type of public transportation, at least one carrier such as including but not limited to Fed Ex, UPS, US mail, Parcel post, other delivery service; invoking and/or performing at least one intermediate operation that can include but is not limited to Xeroxing, binding, collating, addressing, packaging, other clerical functions, filing papers in court, paying fees, getting filing receipts, and taking any at least one other action necessary to effect delivery of at least one Package; and/or performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, and/or taking any other action necessary.

The step of response of at least one Courier 74 can be via at least one means providing at least one of including but not limited to name and/or identifying information, location, availability, at least one method of transportation available, at least one skill set necessary to perform said at least one intermediate operation.

The step of awarding the assignment for order fulfillment or a part thereof to at least one Courier 75 can be made using at least one of the following criteria: first to respond, physical strength or other physical attribute, previous experience with special handling conditions of the type of Package to be delivered, mechanical aptitude, technical expertise, language skills, intelligence, professional demeanor, personal hygiene, reliability and/or punctuality, speed necessity of order fulfillment, mental health history, academic achievement, law enforcement experience, legal experience, military experience, special occupational experience, special licenses including but not limited to automobile, truck, motorcycle, boat, pilot, firearms, notary public in at least one state, at least one other criteria.

The step of transportation fulfillment 76 can comprise at least one of the following that can occur: at least one Courier takes custody of at least one Package at at least one Pick-up location, transports at least one Package to at least one Transfer location, picks up at least one Package from at least one Transfer location, delivers at least one Package to at least one Drop-off location, and/or maintains at least one Chain of custody.

The step of closing out transaction upon at least one Package delivery 77 can include at least one of the following: delivery of at least one Package to at least one Drop-off location; securing at least one signature of at least one Authorized Person to confirm at least one Chain of custody proof; at least one Courier notification can be made to the Company informing that at least one Package has been delivered to at least one Drop-off location; company can notify Notification Parties by at least one selected method of notification including but not limited to: e-mail, text, phone and/or voice message, electronic data transmission, social network, internet, intranet, Ethernet, smart device transmission and or reception. This notification may include at least one signature of at least one Authorized Person who signed for at least one Package at at least one Drop-off location.

In another embodiment, the invention is a program or series of programs residing on at least one computer that is an application and/or program for communicating and interacting with human and/or machine components as applicable to the Customer user's interface with the Company and/or at least one Courier involved in at least one Package retrieval, transport, and delivery comprising at least one of the following steps: downloading app and/or initiate or initiate application from web-based program 80 or website from the Company, register and/or sign-in to at least one of an application, web-based program, website, and/or other means 81, entering Service Request 82, scheduling at least one pick-up time 83, scheduling at least one delivery time 84, selecting at least one Courier service type 85, specifying at least one Package contents 86, specification and/or special work description of at least one intermediate operation 87, confirmation of data input before this step 88, choosing method of payment 89, payment confirmation 90, specifying notification 91, notification Parties receives confirmation 92 of order in specified methods of notification, at least one Courier arrives at at least one Sender's Pick-up location at at least one designated time 93, at least one Courier arrives at at least one Receiver's Drop-off location at at least one designated time 94, at least one Notification received by Notification Parties 95, billing Authorized payer when required 96, and funds are then released to Company unless prepaid and/or on open account;

The step of register and/or sign-in to at least one of an application, web-based program, website, and/or other means 81 can comprise at least one of the following steps: filling in at least one profile data field and/or sign-in by entering at least one of: user name, password, at least one other sign-in request or requirement with or without auto fill and/or adding to at least one menu;

The step of entering Service Request 82 can comprise at least one of the following steps: entering Order Placer information, entering at least one Pick-up and/or Sender set of information, and/or entering at least one drop-off and/or Receiver set of information.

Entering Order Placer information can comprise at least one of the following: entering name or selecting from at least one menu with or without auto fill and/or adding to at least one menu; entering at least one e-mail address and/or selecting from at least one menu with or without auto fill and/or adding to at least one menu; entering at least one phone number and/or selecting from at least one menu with or without auto fill and/or adding to at least one menu; entering other information that is at least one of screen name, additional phone number, additional e-mail address, customer code or account, other information that may be requested or required, and/or selecting from at least one menu with or without auto fill and/or adding to at least one menu; entering at least one amount of insurance necessary; and/or deleting at least one pre-existing data from at least one at least one menu.

Entering at least one Pick-up and/or Sender set of information can comprise at least one of the following: entering at least one Authorized Person's name and/or selecting from at least one menu with or without auto fill and/or adding to at least one menu; entering at least one Sender and/or Pick-up location and/or selecting from at least one menu with or without auto fill and/or adding to at least one menu; enabling or disabling at least one Geo-location; entering at least one pick-up and/or Sender e-mail address and/or selecting from at least one menu with or without auto fill and/or adding to at least one menu; entering at lest one pick-up and/or Sender phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement; entering at least one third Party acceptability; and/or deleting at least one pre-existing data from at least one at least one menu.

Entering at least one drop-off and/or Receiver set of information can comprise at least one of the following: entering at least one Authorized Person's name and/or selecting from at least one menu with or without auto fill and/or adding to at least one menu; entering at least one Receiver and/or Drop-off location and/or selecting from at least one menu with or without auto fill and/or adding to at least one menu; enabling or disabling at least one Geo-location; entering at least one Receiver and/or drop-off e-mail address and/or selecting from at least one menu with or without auto fill and/or adding to at least one menu; entering at least one Receiver and/or drop-off phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement and who is at least one Authorized Person to sign for at least one Package and/or selecting from at least one menu with or without auto fill and/or adding to at least one menu; entering at least one third Party acceptability to accept at least one Package; and/or deleting at least one pre-existing data from at least one at least one menu.

The step of scheduling at least one pick-up time 83 can comprise specification of at least one of the following: choosing at least one time; choosing at least one level of urgency that comprises immediately and/or at least one delivery window of tolerance.

The step of scheduling at least one delivery time 84 can comprise specification of at least one of the following: choosing at least one the time; choosing at least one level of urgency that comprises immediately and/or at least one delivery window of tolerance.

The step of selecting at least one Courier service type 85 can comprise at least one of: selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting previously stored selections; selecting at least one outside services employed using at least one of Fed Ex, UPS, US mail, Parcel post, other delivery service, don't care, selecting at least one previously stored selection and provide necessary information so said outside service can be invoked; and/or deleting at least one pre-existing data from at least one at least one menu.

The step of specifying at least one Package contents 86 can comprise at least one of the following attributes: at least one of liquid, solid, biological, living, animal, plant, chemical; at least one of toxicity, explosive, dusty, foul and/or strange aroma; at least one Package size; at least one approximate weight; at least one of at least one Package fragility, orientation to the vertical, at least one special handling instruction and/or free form notes, selecting at least one previously stored selection; at least one other requested or required attribute and/or other data; and/or deleting at least one pre-existing data from at least one at least one menu.

The step of specification and/or special work description of at least one intermediate operation 87 can include but is not limited to Xeroxing, binding, collating, addressing, packaging, other clerical functions, filing papers in court, paying fees, getting filing receipts, and taking any at least one other action necessary to effect delivery of at least one Package.

The step of confirmation of data input before this step 88 can comprise one of the choices: yes, to signify an official submission of order then continue to method of payment, or no to re-enter data and confirm data re-entry.

The step of choosing method of payment 89 can be at least one of the following: pre-paid; open account; credit card; Paypal and/or other money on line services that can withdraw money directly from at least one of credit cards, debit cards, bank accounts; wire transfer; and/or electronic transfer directly from bank account.

The step of payment confirmation 90 can be at least one of the following choices: yes, and continue to next step; or no, to make another arrangement and return to method of payment.

The step of specifying notification 91 can include at least one of: specification of all Notification Parties Receiver confirmation of order is to be sent, which comprises at least one of at least one Order Placer, Sender, Receiver, at least one new customer and/or company, Authorized Person; and/or confirmation of order for all said Notification Parties to be notified in at least one of the following selectable methods of notification: e-mail, text, phone and/or voice message, electronic data transmission, social network, internet, intranet, Ethernet, smart device transmission and or reception.

The step of at least one Courier arrives at at least one Sender's Pick-up location at at least one designated time 93 can require at least one of at least one Authorized Person gives at least one Package to at least one Courier, at least one Authorized Person signs at least one Courier's paperwork, at least one Courier signs at least one Authorized Person's paperwork.

The step of at least one Courier arrives at at least one Receiver's Drop-off location at at least one designated time 94 can require at least one of at least one Authorized Person receives at least one Package from at least one Courier, at least one Authorized Person signs at least one Courier's paperwork, at least one Courier signs at least one Authorized Person's paperwork and/or confirmation or affirmation of at least one other action.

The step of at least one Notification received by Notification Parties 95 by at least one selected method of notification can include but is not limited to: e-mail, text, phone and/or voice message, electronic data transmission, social network, internet, intranet, Ethernet, smart device transmission and or reception.

In another embodiment, the invention is a program or series of programs residing on at least one computer that is an application and/or program for communicating and interacting with human and/or machine components as applicable to the Courier's interface with the Company and/or at least one Customer user involved in at least one Package retrieval, transport, and delivery comprising at least one of the following steps: Fulfillment Request received from a Dispatcher by at least one Courier 100, Fulfillment Request in whole or in part accepted 101, Fulfillment Request assigned as a Job including disseminating instructions and supporting material and/or documentation 102, fulfillment of Job 103, closing out transaction upon at least one Package delivery 104.

The step of Fulfillment Request received from a Dispatcher by at least one Courier 100 within an area that can potentially fulfill the Fulfillment Request in whole or in part can do at least one of the following: retrieve at least one Package from at least one Sender at at least one Pick-up location and/or Transfer location; deliver at least one Package to at least one Drop-off location and/or at least one other Transfer location; invoke and/or perform at least one intermediate value added operation including but not limited to Xeroxing, binding, collating, addressing, packaging, other clerical functions, filing papers in court, paying fees, getting filing receipts, and taking any at least one other action necessary; abide by the handling conditions of said Fulfillment Request, perform at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.

The step of Fulfillment Request assigned as a Job including disseminating instructions and supporting material and/or documentation 102 can contain at least one of the following functions: retrieving at least one Package from at least one Sender at at least one Pick-up location and/or Transfer location; delivering at least one Package to at least one Drop-off location and/or at least one other Transfer location; invoking and/or performing at least one intermediate value added operation including but not limited to Xeroxing, binding, collating, addressing, packaging, other clerical functions, filing papers in court, paying fees, getting filing receipts, and taking any at least one other action necessary; abiding by the handling conditions of said Job; and/or performing at least one of any other operation and/or function necessary to affect Job fulfillment and communication with the Company and/or at least one Authorized Person to define and/or redefine at least one of including but not limited to progress at at least one step in the fulfillment process, articulating any problems encountered, taking corrective action, affecting damage control, performing any other action necessary.

The step of closing out transaction upon at least one Package delivery 104 can includes at least one of the following: at least one Package delivery to at least one Drop-off location; securing at least one signature of at least one Authorized Person to confirm at least one Chain of custody proof; at least one Authorized Person informing Company that all order fulfillment functions have been successfully performed; and/or at least one Courier notification to Company that at least one Package has been delivered to at least one Drop-off location.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF DRAWINGS

FIG. 1 is a flowchart diagram of the steps corresponding to sections 1A-1M of claim 1 involving the Company, the Customer user, and the Courier.

FIG. 2 is a flowchart diagram of the steps corresponding to sections 2A-2I of claim 1 involving the Company component.

FIG. 3 is a flowchart diagram of the steps corresponding to sections 3A-3Q of claim 1 involving the Customer user component.

FIG. 4 is a flowchart diagram of the steps corresponding to sections 4A-4E of claim 1 involving the Courier component.

FIG. 5 is a flowchart diagram of the steps corresponding to sections A-I of claim 2 involving the Company component.

FIG. 6 is a flowchart diagram of the steps corresponding to sections A-Q of claim 3 involving the Customer user component.

FIG. 7 is a flowchart diagram of the steps corresponding to sections A-E of claim 4 involving the Courier component.

### COMPONENTS

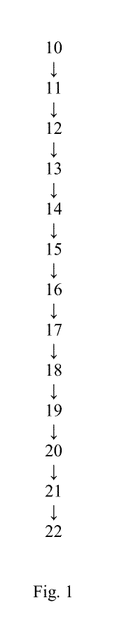

FIG. 1 1A-1M
10 Download app and/or initiate app or initiate application from web-based program
11 Register and/or Sign-in to at least one of an application, web-based program, website, and/or other means
12 Service Request
13 Schedule at least one pick-up time
14 Schedule at least one delivery time
15 Select at least one Courier service type
16 Specify at least one Package contents
17 Specification and/or special work description of at least one intermediate operation
18 Confirmation of data input
19 Choosing method of payment
20 Payment confirmation
21 Specifying notification
22 Company and Notification Parties receives confirmation of order

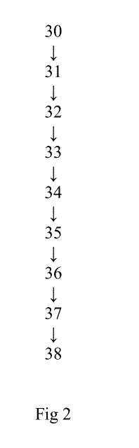

FIG. 2 2A-2I
30 Receiving Service Request
31 Reformatting Service Request to fit at least one template
32 Devising at least one Package delivery fulfillment strategy
33 Fulfillment Request submitted by a Dispatcher to at least one Courier
34 Response of at least one Courier
35 Awarding the assignment for order fulfillment or a part thereof to at least one Courier
36 Transportation fulfillment
37 Closing out transaction upon at least one Package delivery
38 Billing Authorized payer when required

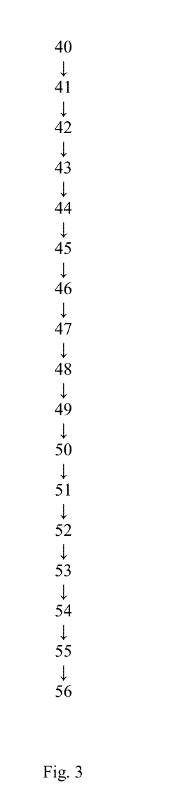

FIG. 3 3A-3Q
40 Downloading app and/or initiate or initiate application from web-based program
41 Register and/or Sign-in to at least one of an application, web-based program, website, and/or other means
42 Entering Service Request
43 Scheduling at least one pick-up time
44 Scheduling at least one delivery time
45 Selecting at least one Courier service type
46 Specifying at least one Package contents
47 Specification and/or special work description of at least one intermediate operation
48 Confirmation of data input before this step
49 Choosing method of payment
50 Payment confirmation
51 Specifying notification
52 Notification Parties receives confirmation
53 At least one of at least one Courier arrives at at least one Sender's Pick-up location at at least one designated time
54 At least one of at least one Courier arrives at at least one Receiver's Drop-off location at at least one designated time
55 At least one Notification received by Notification Parties
56 Billing Authorized payer when required

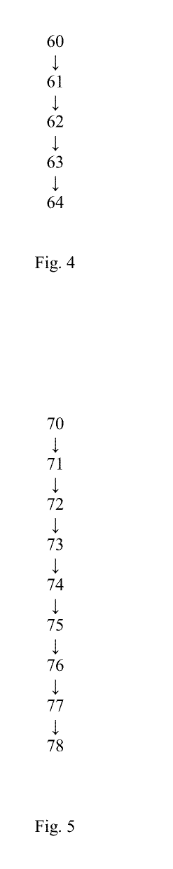

FIG. 4 4A-4E
60 Fulfillment Request received from a Dispatcher by at least one Courier
61 Fulfillment Request in whole or in part accepted
62 Fulfillment Request assigned as a Job including disseminating instructions and supporting material and/or documentation
63 Fulfillment of Job
64 Closing out transaction upon at least one Package delivery

FIG. 5 A-I
70 Receive Service Request
71 Reformatting Service Request to fit at least one template
72 Devising at least one Package delivery fulfillment strategy
73 Fulfillment Request submitted by a Dispatcher to at least one Courier
74 Response of at least one Courier
75 Awarding the assignment for order fulfillment or a part thereof to at least one Courier
76 Transportation fulfillment
77 Closing out transaction upon at least one Package delivery
78 Billing Authorized payer when required

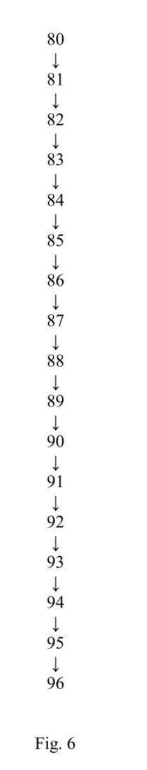

FIG. 6 A-Q
80 Download app and/or initiate app or initiate application from web-based program
81 Register and/or Sign-in to at least one of an application, web-based program, website, and/or other means
82 Entering Service Request
83 Scheduling at least one pick-up time
84 Scheduling at least one delivery time
85 Selecting at least one Courier service type
86 Specifying at least one Package contents
87 Specification and/or special work description of at least one intermediate operation
88 Confirmation of data input before this step
89 Choosing method of payment
90 Payment confirmation
91 Specifying notification
92 Notification Parties receives confirmation
93 At least one of at least one Courier arrives at at least one Sender's Pick-up location at at least one designated time
94 At least one of at least one Courier arrives at at least one Receiver's Drop-off location at at least one designated time
95 At least one Notification received by Notification Parties
96 Billing Authorized payer when required

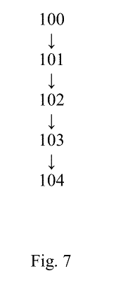

FIG. 7 A-E
100 Fulfillment Request received from a Dispatcher by at least one Courier
101 Fulfillment Request in whole or in part accepted
102 Fulfillment Request assigned as a Job including disseminating instructions and supporting material and/or documentation
103 Fulfillment of Job
104 Closing out transaction upon at least one Package delivery

### DEFINITIONS

Authorized Person: at least one person at any location who is authorized to do at least one of sign for something, change an order, place an order, pay for an order, have at least one Package picked up from and/or dropped off to, legally represent, speak and/or represent and/or transact business on behalf of at least one other Authorized Person.

Auto fill: the automatic completion of a data entry and/or presentation of at least one data entry choice within at least one displayed menu in a data field based on at least one entry of at least one alpha-numeric character and/or cursor position.

Chain of custody: maintaining control of at least one Package between at least one Pick-up location and at least one Drop-off location, with full documentation at each transfer of a Package or Packages between any Authorized Person at at least one Pick-up location and a Courier, any Courier and any other Courier, and any Courier and at least one Authorized Person at at least one Drop-off location. Said documentation includes for each transfer of at least one Package at least one of time, date, Job and/or tracking number, contact information, other information, at least one signature of at least one Authorized Person taking custody of at least one Package.

Company: An organization having the duties, responsibilities, and liabilities described herein to interact with all Parties to facilitate the placement, fulfillment, and tracking of an order.

Courier: at least one messenger, driver, delivery person and/or robotic device and/or drone of any kind and number involved in at least one Package movement fulfillment chain between at least one Pick-up location and at least one Drop-off location.

Customer user: at least one Order Placer, Sender and/or pick-up person and/or Authorized Person located at at least one Pick-up location, Receiver and/or drop-off person and/or Authorized Person at at least one Drop-off location, authorized payer.

Dispatcher: The person at a central office of the company, possibly within a region, and this person calls on a telephone or informs by any means at least one address from which at least one Package must be picked up from or dropped off to. The Dispatcher can be a human, an automated process, or any combination.

Drop-off location: the location where at least one Package is dropped off by at least one Courier. This may involve at least one person or Authorized Person at this location signing for at least one Package in the presence of at least one Courier and or at least one Courier signing at least one Authorized Person's paperwork.

Fulfillment Request: the reformatted statement of work contained within Service Request which contains at least one request for Package pick-up and/or drop-off and/or other intermediate work that is disseminated from a Dispatcher to at least one Courier.

Geo-tracking/Geo-location: the latitude and longitude and/or address or other form of spatial location of where something or someone is. This can be automatically linked to an address or other information entered or can be determined using global position from either a GPS unit or other smart electronic device containing GPS circuitry.

Job: when a Fulfillment Request has been accepted and approved, the entire embodiment or a portion thereof of the work necessary for at least one Courier to perform.

Notification Parties: any Party/Parties to be notified of progress at any specified stage of the entire fulfillment process including the placement of an order, pick-up of at least one Package, tracking of at least one Package, status of at least one Package, drop-off of at least one Package, payment. Notification can occur by any number and combination of methods.

Order Placer: The person or User who places an order. This may or may not be the same person or company from which at least one Package is picked up or dropped off. For instance, Person A can place the order for at least one Package to be picked up from Person B and delivered to and dropped off at Person C. The Order Placer may or may not be the authorized payee.

Package or Packages: at least one of any object and/or material having mass and taking up space that can be contained and transported including but not limited to boxes, envelopes, information containing objects and/or devices, books, magazines, anything containing print and/or printed material, cash, coins, checks, money orders, jewelry, precious metals, legal documents, perishables of any type, plants, animals, organs, medically needed materials of any type, food, liquids, beverages, containers, canisters containing gas at any pressure, manufactured objects, mechanisms and/or machinery, electronics and/or devices containing electronics, art, sculpture, furniture, antiques, dangerous and/or extremely delicate materials and/or substances.

Party/Parties: include at least one of the following: at least one Order Placer, Sender and/or pick-up person and/or Authorized Person located at at least one Pick-up location, Receiver and/or drop-off person and/or Authorized Person at at least one Drop-off location, authorized payer, Courier, employee, agent, heir, and assign of the Company and/or City Msgr.

Pick-up location: the location where at least one Package is picked up by at least one Courier. This may involve at least one Courier signing for at least one Package in the presence of at least one Authorized Person at this location or at least one Authorized Person signing any paperwork, electronic or otherwise, of the Courier.

Receiver: at least one of at least one customer, company, pick-up person, Authorized Person at at least one Drop-off location.

Sender: at least one of at least one customer, company, pick-up person, Authorized Person at at least one Pick-up location.

Service Request: the embodiment of the statement of work requested and required by an Order Placer.

Transfer location: An intermediate location in the Transportation fulfillment of at least one Package between at least one Pick-up location and at least one Drop-off location. In this scenario a first Courier would hand off at least one Package to a second Courier, and to maintain the Chain of custody the second Courier would sign for at least one Package and/or note at least one other tracking parameter such as including but not limited to obtaining at least one Courier signature, at least one time and/or date of transfer, at least one Job and/or tracking number, communication with the Dispatcher and/or the Company, document at least one location which can either employ or not employ Geo-tracking, and/or supply at least one form of contact information.

Transportation fulfillment: the physical acquisition, transport, and delivery of at least one Package between at least one Pick-up location and at least one Drop-off location in accordance with any special transportation requirements. This may require the use of more than one Courier, which involves passing at least one Package from one Courier to the next. Transportation fulfillment may or may not involve tracking of at least one Package.

### DETAILED DESCRIPTION OF DRAWINGS

FIG. 1 is a flowchart diagram of the steps corresponding to sections 1A-1M of claim 1 involving the Company, the Customer user, and the Courier.

More specifically, from the point of view of the Company and at least one Customer user and at least one Courier, the invention is an application and/or program for communicating and interacting with human and/or machine components involved in at least one Package retrieval, transport, and delivery that can comprise at least one of the following steps:

Download app and/or initiate app or initiate application from web-based program 10 as depicted in FIG. 1, and requires the Company to provide the necessary software and for at least one Customer user to download this software.

Upon downloading, at least one Customer user could register and/or sign-in to at least one of an application, web-based program, website, and/or other means 11 as depicted in FIG. 1. The step to register and/or sign-in to at least one of an application, web-based program, website, and/or other means 11 can comprise at least one of the following steps: filling in at least one profile data field, sign-in by entering at least one of: user name, password, at least one other sign-in request or requirement with or without auto fill and/or add to at least one menu which can be a drop down menu or other menu display.

Another step is depicted in FIG. 1 and could be the Service Request 12, which can comprise at least one of the following steps: entering Order Placer information, entering pick-up information, and entering at least one drop-off and/or Receiver information.

Order Placer information entry can comprise at least one of the following: entering name or selecting from at least one menu with or without auto fill and/or adding to at least one menu; entering at least one e-mail address and/or selecting from at least one menu with or without auto fill and/or adding to at least one menu; entering at least one phone number and/or selecting from at least one menu with or without auto fill and/or adding to at least one menu; entering other information that is at least one of screen name, additional phone number, additional e-mail address, customer code and/or account, other information that may be requested or required, and/or selecting from at least one menu with or without auto fill and/or adding to at least one menu; entering at least one amount of insurance necessary; and/or deleting at least one pre-existing data from at least one at least one menu.

Pick-up information entry can comprise at least one of the following: entering at least one Authorized Person's name and/or selecting from at least one menu with or without auto fill and/or adding to at least one menu; entering at least one Sender and/or Pick-up location and/or selecting from at least one menu with or without auto fill and/or adding to at least one menu; enabling or disabling at least one Geo-location; entering at least one Sender and/or pick-up e-mail address and/or selecting from at least one menu with or without auto fill and/or adding to at least one menu; entering at least one pick-up phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement; entering at least one third Party acceptability; and/or deleting at least one pre-existing data from at least one at least one menu.

Entering at least one drop-off and/or Receiver information can comprise at least one of the following: entering at least one Authorized Person's name and/or selecting from at least one menu with or without auto fill and/or adding to at least one menu; entering at least one Receiver and/or Drop-off location and/or selecting from at least one menu with or without auto fill and/or adding to at least one menu; enabling or disabling at least one Geo-location; entering at least one Receiver and/or drop-off e-mail address and/or selecting from at least one menu with or without auto fill and/or adding to at least one menu; entering at least one Receiver and/or drop-off phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement and who is at least one Authorized Person to sign for at least one Package and/or selecting from at least one menu with or without auto fill and/or adding to at least one menu; entering at least one third Party acceptability to accept Package; and/or deleting at least one pre-existing data from at least one at least one menu.

Another step is depicted in FIG. 1 and could be to schedule at least one pick-up time 13, and this step can comprise specification of at least one of the following: choosing at least one time; choosing at least one level of urgency that comprises immediately and/or at least one delivery window of tolerance.

Another step could be to schedule at least one delivery time 14, and this step can comprise specification of at least one of the following: choosing at least one time, and/or choosing at least one level of urgency that comprises immediately and/or at least one delivery window of tolerance.

Another step is depicted in FIG. 1 and could be to select at least one Courier service type 15, and this step can comprise at least one of: selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting at least one previously stored selection; selecting at least one outside services employed using at least one of Fed Ex, UPS, US mail, Parcel post, other delivery service, don't care, selecting at least one previously stored selection and provide necessary information so the outside service can be invoked; and/or deleting at least one pre-existing data from at least one at least one menu.

Another step is depicted in FIG. 1 and could be to specify at least one Package contents 16, and this step can comprise at least one of the following attributes: at least one of liquid, solid, biological, living, animal, plant, chemical; at least one of toxicity, explosive, dusty, foul and/or strange aroma; at least one Package size; at least one approximate weight; at least one of at least one Package fragility, orientation to the vertical, specifying special handling instructions and/or free form notes, selecting at least one previously stored selection; at least one other requested or required attribute and/or other data; and/or deleting at least one pre-existing data from at least one at least one menu.

Another step is depicted in FIG. 1 and could be specification and/or special work description of at least one intermediate operation 17, and this step can include but is not limited to Xeroxing, binding, collating, addressing, packaging, other clerical functions, filing papers in court, paying fees, getting filing receipts, and taking any at least one other action necessary to effect delivery of at least one Package.

Another step is depicted in FIG. 1 and could be confirmation of data input 18 before this step and this step can comprise one of the choices: yes, which can equal an official submission of order then continue to method of payment; or no, which can require a need to re-enter data and have confirmation of data re-entry.

Another step is depicted in FIG. 1 and could be choosing method of payment 19, which can be at least one of the following: pre-paid; open account; credit card; Paypal and/or other money on line services that can withdraw money directly from at least one of credit cards, debit cards, bank accounts; wire transfer; electronic transfer directly from bank account.

Another step is depicted in FIG. 1 and could be payment confirmation 20, which can be at least one of the following choices: yes, and continue to next step; or no, and make another arrangement and return to method of payment 19.

Another step is depicted in FIG. 1 and could be specifying notification 21, and this step can include at least one of: specification of all Notification Parties Receiver confirmation of order is to be sent, which can comprise at least one of at least one Order Placer, Sender, Receiver, at least one new customer and/or company, Authorized Person; and confirmation of order for all Notification Parties to be notified in at least one of the following selectable methods of notification: e-mail, text, phone and/or voice message, electronic data transmission, social network, internet, intranet, Ethernet, smart device transmission and or reception.

Another step is depicted in FIG. 1 and could be Company and Notification Parties receives confirmation of order 22 in all specified methods of notification. FIG. 2 is a flowchart diagram of the steps corresponding to sections 2A-2I of claim 1 involving the Company component and from the Company's interface with at least one Customer user and/or at least one Courier, this and can comprise at least one of the following steps:

Receiving Service Request 30, which can be via at least one of the web or a website, an app, e-mail, text, phone call and/or voice message, social media, instant message, encrypted or unencrypted instructions received in storage medium of any kind

Another step is depicted in FIG. 2 and could be reformatting Service Request to fit at least one template 31.

Another step is depicted in FIG. 2 and could be devising at least one Package delivery fulfillment strategy 32, which can include at least one of: a short-distance delivery model that can comprise the same Courier picking up at least one Package at at least one Pick-up location and dropping off at least one Package at at least one Drop-off location employing walking and one other form of motorized or non-motorized transportation; a mid-distance delivery model that can comprise the same Courier picking up at least one Package at at least one Pick-up location and dropping off at least one Package at at least one Drop-off location employing walking and multiple forms of motorized and/or non-motorized transportation which may or may not include public transportation; a long-distance delivery model that can comprise the same or more than one Courier to provide Job fulfillment employing at least two of the following: walking, at least one form of motorized and/or non-motorized transportation, at least one type of public transportation, at least one carrier such as including but not limited to Fed Ex, UPS, US mail, Parcel post, other delivery service; invoking and/or performing at least one intermediate operation that can include but is not limited to Xeroxing, binding, collating, addressing, packaging, other clerical functions, filing papers in court, paying fees, getting filing receipts, and taking any at least one other action necessary to effect delivery of at least one Package; and/or performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, and/or taking any other action necessary.

Another step is depicted in FIG. 2 and could be Fulfillment Request submitted by a Dispatcher to at least one Courier 33 within an area who can potentially fulfill said Fulfillment Request in whole or in part.

Another step is depicted in FIG. 2 and could be the response of at least one Courier 34, which can be via at least one means providing at least one of including but not limited to name and/or identifying information, location, availability, at least one method of transportation available, at least one skill set necessary to perform said at least one intermediate operation.

Another step is depicted in FIG. 2 and could be awarding the assignment for order fulfillment or a part thereof to at least one Courier 35, wherein the decision of which Courier is awarded the assignment for order fulfillment or a part thereof can be made using at least one of the following criteria: first to respond, physical strength or other physical attribute, previous experience with special handling conditions of the type of Package to be delivered, mechanical aptitude, technical expertise, language skills, intelligence, professional demeanor, personal hygiene, reliability and/or punctuality, speed necessity of order fulfillment, mental health history, academic achievement, law enforcement experience, legal experience, military experience, special occupational experience, special licenses including but not limited to automobile, truck, motorcycle, boat, pilot, firearms, notary public in at least one state, at least one other criteria.

Another step is depicted in FIG. 2 and could be transportation fulfillment 36 wherein at least one of the following can occur: at least one Courier takes custody of at least one Package at at least one Pick-up location, transports at least one Package to at least one Transfer location, picks up at least one Package from at least one Transfer location, delivers at least one Package to at least one Drop-off location, and/or maintains at least one Chain of custody.

Another step is depicted in FIG. 2 and could be closing out transaction upon at least one Package delivery 37, which can include at least one of the following: delivery of at least one Package to at least one Drop-off location; securing at least one signature of at least one Authorized Person to confirm at least one Chain of custody proof; at least one Courier notification can be made to the Company informing that at least one Package has been delivered to at least one Drop-off location; company can notify Notification Parties by at least one selected method of notification including but not limited to: e-mail, text, phone and/or voice message, electronic data transmission, social network, internet, intranet, Ethernet, smart device transmission and or reception. This notification may include at least one signature of at least one Authorized Person who signed for at least one Package at at least one Drop-off location.

Another step is depicted in FIG. 2 and could be billing Authorized payer when required 38, and funds can then be released to Company unless prepaid and/or on open account.

FIG. 3 is a flowchart diagram of the steps corresponding to sections 3A-3Q of claim 1 involving the Customer user component and from the Customer user's interface with the Company and/or at least one Courier, this and can comprise at least one of the following steps:

Downloading app and/or initiate or initiate application from web-based program 40 or website from the Company.

Another step is depicted in FIG. 3 and could be to register and/or sign-in to at least one of an application, web-based program, website, and/or other means 41, which can comprise at least one of the following steps: filling in at least one profile data field and/or sign-in by entering at least one of: user name, password, at least one other sign-in request or requirement with or without auto fill and/or adding to at least one menu.

Another step is depicted in FIG. 3 and could be entering Service Request 42, which can comprise at least one of the following steps: entering Order Placer information, entering at least one pick-up and/or Sender set of information, and/or entering at least one drop-off and/or Receiver set of information.

Entering Order Placer information can comprise at least one of the following: entering name or selecting from at least one menu with or without auto fill and/or adding to at least one menu; entering at least one e-mail address and/or selecting from at least one menu with or without auto fill and/or adding to at least one menu; entering at least one phone number and/or selecting from at least one menu with or without auto fill and/or adding to at least one menu; entering other information that is at least one of screen name, additional phone number, additional e-mail address, customer code or account, other information that may be requested or required, and/or selecting from at least one menu with or without auto fill and/or adding to at least one menu; entering at least one amount of insurance necessary; and/or deleting at least one pre-existing data from at least one at least one menu.

Entering at least one Pick-up and/or Sender set of information can comprise at least one of the following: entering at least one Authorized Person's name and/or selecting from at least one menu with or without auto fill and/or adding to at least one menu; entering at least one Sender and/or Pick-up location and/or selecting from at least one menu with or without auto fill and/or adding to at least one menu; enabling or disabling at least one Geo-location; entering at least one pick-up and/or Sender e-mail address and/or selecting from at least one menu with or without auto fill and/or adding to at least one menu; entering at lest one pick-up and/or Sender phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement; entering at least one third Party acceptability; and/or deleting at least one pre-existing data from at least one at least one menu.

Entering at least one drop-off and/or Receiver set of information can comprise at least one of the following: entering at least one Authorized Person's name and/or selecting from at least one menu with or without auto fill and/or adding to at least one menu; entering at least one Receiver and/or Drop-off location and/or selecting from at least one menu with or without auto fill and/or adding to at least one menu; enabling or disabling at least one Geo-location; entering at least one Receiver and/or drop-off e-mail address and/or selecting from at least one menu with or without auto fill and/or adding to at least one menu; entering at least one Receiver and/or drop-off phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement and who is at least one Authorized Person to sign for at least one Package and/or selecting from at least one menu with or without auto fill and/or adding to at least one menu; entering at least one third Party acceptability to accept at least one Package; and/or deleting at least one pre-existing data from at least one at least one menu.

Another step is depicted in FIG. 3 and could be scheduling at least one pick-up time 43, which can comprise specification of at least one of the following: choosing at least one time; choosing at least one level of urgency that comprises immediately and/or at least one delivery window of tolerance.

Another step is depicted in FIG. 3 and could be scheduling at least one delivery time 44, which can comprise specification of at least one of the following: choosing at least one the time; choosing at least one level of urgency that comprises immediately and/or at least one delivery window of tolerance.

Another step is depicted in FIG. 3 and could be selecting at least one Courier service type 45, which can comprise at least one of: selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting previously stored selections; selecting at least one outside services employed using at least one of Fed Ex, UPS, US mail, Parcel post, other delivery service, don't care, selecting at least one previously stored selection and provide necessary information so said outside service can be invoked; and/or deleting at least one pre-existing data from at least one at least one menu.

Another step is depicted in FIG. 3 and could be specifying at least one Package contents 46, which can comprise at least one of the following attributes: at least one of liquid, solid, biological, living, animal, plant, chemical; at least one of toxicity, explosive, dusty, foul and/or strange aroma; at least one Package size; at least one approximate weight; at least one of at least one Package fragility, orientation to the vertical, at least one special handling instruction and/or free form notes, selecting at least one previously stored selection; at least one other requested or required attribute and/or other data; and/or deleting at least one pre-existing data from at least one at least one menu.

Another step is depicted in FIG. 3 and could be specification and/or special work description of at least one intermediate operation 47, which can include but is not limited to Xeroxing, binding, collating, addressing, packaging, other clerical functions, filing papers in court, paying fees, getting filing receipts, and taking any at least one other action necessary to effect delivery of at least one Package.

Another step is depicted in FIG. 3 and could be confirmation of data input before this step 48, which can comprise one of the choices: yes, to signify an official submission of order then continue to method of payment, or no to re-enter data and confirm data re-entry.

Another step is depicted in FIG. 3 and could be choosing method of payment 49, which can be at least one of the following: pre-paid; open account; credit card; Paypal and/or other money on line services that can withdraw money directly from at least one of credit cards, debit cards, bank accounts; wire transfer; and/or electronic transfer directly from bank account.

Another step is depicted in FIG. 3 and could be payment confirmation 50, which can be at least one of the following choices: yes, and continue to next step; or no, to make another arrangement and return to method of payment above.

Another step is depicted in FIG. 3 and could be specifying notification 51, which can include at least one of: specification of all Notification Parties Receiver confirmation of order is to be sent, which comprises at least one of at least one Order Placer, Sender, Receiver, at least one new customer and/or company, Authorized Person; and/or confirmation of order for all said Notification Parties to be notified in at least one of the following selectable methods of notification: e-mail, text, phone and/or voice message, electronic data transmission, social network, internet, intranet, Ethernet, smart device transmission and or reception.

Another step is depicted in FIG. 3 and could be notification Parties receives confirmation 52 of order in specified methods of notification.

Another step is depicted in FIG. 3 and could be at least one Courier arrives at at least one Sender's Pick-up location at at least one designated time 53, which can require at least one of at least one Authorized Person gives at least one Package to at least one Courier, at least one Authorized Person signs at least one Courier's paperwork, at least one Courier signs at least one Authorized Person's paperwork.

Another step is depicted in FIG. 3 and could be at least one Courier arrives at at least one Receiver's Drop-off location at at least one designated time 54, which can require at least one of at least one Authorized Person receives at least one Package from at least one Courier, at least one Authorized Person signs at least one Courier's paperwork, at least one Courier signs at least one Authorized Person's paperwork and/or confirmation or affirmation of at least one other action.

Another step is depicted in FIG. 3 and could be at least one Notification received by Notification Parties 55 by at least one selected method of notification can include but is not limited to: e-mail, text, phone and/or voice message, electronic data transmission, social network, internet, intranet, Ethernet, smart device transmission and or reception.

Another step is depicted in FIG. 3 and could be billing Authorized payer when required 56, and funds can then released to Company unless prepaid and/or on open account.

FIG. 4 is a flowchart diagram of the steps corresponding to sections 4A-4E of claim 1 involving the Courier component and from the Courier's interface with the Company and/or at least one Customer user, and this and can comprise at least one of the following steps:

Fulfillment Request received from a Dispatcher by at least one Courier 60 within an area that can potentially fulfill the Fulfillment Request in whole or in part can do at least one of the following: retrieve at least one Package from at least one Sender at at least one Pick-up location and/or Transfer location; deliver at least one Package to at least one Drop-off location and/or at least one other Transfer location; invoke and/or perform at least one intermediate value added operation including but not limited to Xeroxing, binding, collating, addressing, packaging, other clerical functions, filing papers in court, paying fees, getting filing receipts, and taking any at least one other action necessary; abide by the handling conditions of said Fulfillment Request, perform at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.

Another step is depicted in FIG. 4 and could be a Fulfillment Request in whole or in part accepted 61.

Another step is depicted in FIG. 4 and could be the Fulfillment Request assigned as a Job including disseminating instructions and supporting material and/or documentation 62, which can define at least one of the following functions: retrieving at least one Package from at least one Sender at at least one Pick-up location and/or Transfer location; delivering at least one Package to at least one Drop-off location and/or at least one other Transfer location; invoking and/or performing at least one intermediate value added operation including but not limited to Xeroxing, binding, collating, addressing, packaging, other clerical functions, filing papers in court, paying fees, getting filing receipts, and taking any at least one other action necessary; abiding by the handling conditions of said Job; and/or performing at least one of any other operation and/or function necessary to affect Job fulfillment and communication with the Company and/or at least one Authorized Person to define and/or redefine at least one of including but not limited to progress at at least one step in the fulfillment process, articulating any problems encountered, taking corrective action, affecting damage control, performing any other action necessary.

Another step is depicted in FIG. 4 and could be fulfillment of Job 63.

Another step is depicted in FIG. 4 and could be closing out transaction upon at least one Package delivery 64, which can includes at least one of the following: at least one Package delivery to at least one Drop-off location; securing at least one signature of at least one Authorized Person to confirm at least one Chain of custody proof; at least one Authorized Person informing Company that all order fulfillment functions have been successfully performed; and/or at least one Courier notification to Company that at least one Package has been delivered to at least one Drop-off location.

FIG. 5 is a flowchart diagram of the steps corresponding to sections A-I of claim 2 involving the Company component and from the Company's interface with at least one Customer user and/or at least one Courier, this and can comprise at least one of the following steps:

Receive Service Request 70 which can be via at least one of the web or a website, an app, e-mail, text, phone call and/or voice message, social media, instant message, encrypted or unencrypted instructions received in storage medium of any kind

Another step is depicted in FIG. 5 and could be reformatting Service Request to fit at least one template 71.

Another step is depicted in FIG. 5 and could be devising at least one Package delivery fulfillment strategy 72, which can include at least one of: a short-distance delivery model that can comprise the same Courier picking up at least one Package at at least one Pick-up location and dropping off at least one Package at at least one Drop-off location employing walking and one other form of motorized or non-motorized transportation; a mid-distance delivery model that can comprise the same Courier picking up at least one Package at at least one Pick-up location and dropping off at least one Package at at least one Drop-off location employing walking and multiple forms of motorized and/or non-motorized transportation which may or may not include public transportation; a long-distance delivery model that can comprise the same or more than one Courier to provide Job fulfillment employing at least two of the following: walking, at least one form of motorized and/or non-motorized transportation, at least one type of public transportation, at least one carrier such as including but not limited to Fed Ex, UPS, US mail, Parcel post, other delivery service; invoking and/or performing at least one intermediate operation that can include but is not limited to Xeroxing, binding, collating, addressing, packaging, other clerical functions, filing papers in court, paying fees, getting filing receipts, and taking any at least one other action necessary to effect delivery of at least one Package; and/or performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, and/or taking any other action necessary.

Another step is depicted in FIG. 5 and could be a Fulfillment Request submitted by a Dispatcher to at least one Courier 73 within an area who can potentially fulfill said Fulfillment Request in whole or in part.

Another step is depicted in FIG. 5 and could be response of at least one Courier 74, which can be via at least one means providing at least one of including but not limited to name and/or identifying information, location, availability, at least one method of transportation available, at least one skill set necessary to perform said at least one intermediate operation.

Another step is depicted in FIG. 5 and could be awarding the assignment for order fulfillment or a part thereof to at least one Courier 75, and the decision of which Courier is awarded the assignment for order fulfillment or a part thereof can be made using at least one of the following criteria: first to respond, physical strength or other physical attribute, previous experience with special handling conditions of the type of Package to be delivered, mechanical aptitude, technical expertise, language skills, intelligence, professional demeanor, personal hygiene, reliability and/or punctuality, speed necessity of order fulfillment, mental health history, academic achievement, law enforcement experience, legal experience, military experience, special occupational experience, special licenses including but not limited to automobile, truck, motorcycle, boat, pilot, firearms, notary public in at least one state, at least one other criteria.

Another step is depicted in FIG. 5 and could be transportation fulfillment 76 wherein at least one of the following can occur: at least one Courier takes custody of at least one Package at at least one Pick-up location, transports at least one Package to at least one Transfer location, picks up at least one Package from at least one Transfer location, delivers at least one Package to at least one Drop-off location, and/or maintains at least one Chain of custody.

Another step is depicted in FIG. 5 and could be closing out transaction upon at least one Package delivery 77, which can include at least one of the following: delivery of at least one Package to at least one Drop-off location; securing at least one signature of at least one Authorized Person to confirm at least one Chain of custody proof; at least one Courier notification can be made to the Company informing that at least one Package has been delivered to at least one Drop-off location; company can notify Notification Parties by at least one selected method of notification including but not limited to: e-mail, text, phone and/or voice message, electronic data transmission, social network, internet, intranet, Ethernet, smart device transmission and or reception. This notification may include at least one signature of at least one Authorized Person who signed for at least one Package at at least one Drop-off location.

Another step is depicted in FIG. 5 and could be billing Authorized payer when required 78, and funds are then released to Company unless prepaid and/or on open account.

FIG. 6 is a flowchart diagram of the steps corresponding to sections A-Q of claim 3 involving the Customer user component and from the Customer user's interface with the Company and/or at least one Courier, this and can comprise at least one of the following steps:

Downloading app and/or initiate or initiate application from web-based program 80 or website from the Company.

Another step is depicted in FIG. 6 and could be to register and/or sign-in to at least one of an application, web-based program, website, and/or other means 81 which can comprise at least one of the following steps: filling in at least one profile data field and/or sign-in by entering at least one of: user name, password, at least one other sign-in request or requirement with or without auto fill and/or adding to at least one menu.

Another step is depicted in FIG. 6 and could be entering Service Request 82, which can comprise at least one of the following steps: entering Order Placer information, entering at least one Pick-up and/or Sender set of information, and/or entering at least one drop-off and/or Receiver set of information.

Entering Order Placer information can comprise at least one of the following: entering name or selecting from at least one menu with or without auto fill and/or adding to at least one menu; entering at least one e-mail address and/or selecting from at least one menu with or without auto fill and/or adding to at least one menu; entering at least one phone number and/or selecting from at least one menu with or without auto fill and/or adding to at least one menu; entering other information that is at least one of screen name, additional phone number, additional e-mail address, customer code or account, other information that may be requested or required, and/or selecting from at least one menu with or without auto fill and/or adding to at least one menu; entering at least one amount of insurance necessary; and/or deleting at least one pre-existing data from at least one at least one menu.

Entering at least one Pick-up and/or Sender set of information can comprise at least one of the following: entering at least one Authorized Person's name and/or selecting from at least one menu with or without auto fill and/or adding to at least one menu; entering at least one Sender and/or Pick-up location and/or selecting from at least one menu with or without auto fill and/or adding to at least one menu; enabling or disabling at least one Geo-location; entering at least one pick-up and/or Sender e-mail address and/or selecting from at least one menu with or without auto fill and/or adding to at least one menu; entering at lest one pick-up and/or Sender phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement; entering at least one third Party acceptability; and/or deleting at least one pre-existing data from at least one at least one menu.

Entering at least one drop-off and/or Receiver set of information can comprise at least one of the following: entering at least one Authorized Person's name and/or selecting from at least one menu with or without auto fill and/or adding to at least one menu; entering at least one Receiver and/or Drop-off location and/or selecting from at least one menu with or without auto fill and/or adding to at least one menu; enabling or disabling at least one Geo-location; entering at least one Receiver and/or drop-off e-mail address and/or selecting from at least one menu with or without auto fill and/or adding to at least one menu; entering at least one Receiver and/or drop-off phone number and/or selecting from at least one menu with or without auto fill and/or adding to at least one menu; entering other and/or supplemental information that is at least one of screen name, additional phone number, additional e-mail address, customer code and/or account, other information that may be requested or required, and/or selecting from at least one menu with or without auto fill and/or adding to at least one menu; entering at least one signature requirement and who is at least one Authorized Person to sign for at least one Package and/or selecting from at least one menu with or without auto fill and/or adding to at least one menu; entering at least one third Party acceptability to accept at least one Package; and/or deleting at least one pre-existing data from at least one at least one menu.

Another step is depicted in FIG. 6 and could be scheduling at least one pick-up time 83, which can comprise specification of at least one of the following: choosing at least one time; choosing at least one level of urgency that comprises immediately and/or at least one delivery window of tolerance.

Another step is depicted in FIG. 6 and could be scheduling at least one delivery time 84, which can comprise specification of at least one of the following: choosing at least one the time; choosing at least one level of urgency that comprises immediately and/or at least one delivery window of tolerance.

Another step is depicted in FIG. 6 and could be selecting at least one Courier service type 85, which can comprise at least one of: selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting previously stored selections; selecting at least one outside services employed using at least one of Fed Ex, UPS, US mail, Parcel post, other delivery service, don't care, selecting at least one previously stored selection and provide necessary information so said outside service can be invoked; and/or deleting at least one pre-existing data from at least one at least one menu.

Another step is depicted in FIG. 6 and could be specifying at least one Package contents 86, which can comprise at least one of the following attributes: at least one of liquid, solid, biological, living, animal, plant, chemical; at least one of toxicity, explosive, dusty, foul and/or strange aroma; at least one Package size; at least one approximate weight; at least one of at least one Package fragility, orientation to the vertical, at least one special handling instruction and/or free form notes, selecting at least one previously stored selection; at least one other requested or required attribute and/or other data; and/or deleting at least one pre-existing data from at least one at least one menu.

Another step is depicted in FIG. 6 and could be specification and/or special work description of at least one intermediate operation 87, which can include but is not limited to Xeroxing, binding, collating, addressing, packaging, other clerical functions, filing papers in court, paying fees, getting filing receipts, and taking any at least one other action necessary to effect delivery of at least one Package.

Another step is depicted in FIG. 6 and could be confirmation of data input before this step 88, which can comprise one of the choices: yes, to signify an official submission of order then continue to Method of Payment, or no to re-enter data and confirm data re-entry.

Another step is depicted in FIG. 6 and could be choosing method of payment 89, which can be at least one of the following: pre-paid; open account; credit card; Paypal and/or other money on line services that can withdraw money directly from at least one of credit cards, debit cards, bank accounts; wire transfer; and/or electronic transfer directly from bank account.

Another step is depicted in FIG. 6 and could be payment confirmation 90, which can be at least one of the following choices: yes, and continue to next step; or no, to make another arrangement and return to method of payment above.

Another step is depicted in FIG. 6 and could be specifying notification 91, which can include at least one of: specification of all Notification Parties Receiver confirmation of order is to be sent, which comprises at least one of at least one Order Placer, Sender, Receiver, at least one new customer and/or company, Authorized Person; and/or confirmation of order for all said Notification Parties to be notified in at least one of the following selectable methods of notification: e-mail, text, phone and/or voice message, electronic data transmission, social network, internet, intranet, Ethernet, smart device transmission and or reception.

Another step is depicted in FIG. 6 and could be notification Parties receives confirmation 92 of order in specified methods of notification.

Another step is depicted in FIG. 6 and could be at least one Courier arrives at at least one Sender's Pick-up location at at least one designated time 93, which can require at least one of at least one Authorized Person gives at least one Package to at least one Courier, at least one Authorized Person signs at least one Courier's paperwork, at least one Courier signs at least one Authorized Person's paperwork.

Another step is depicted in FIG. 6 and could be at least one Courier arrives at at least one Receiver's Drop-off location at at least one designated time 94, which can require at least one of at least one Authorized Person receives at least one Package from at least one Courier, at least one Authorized Person signs at least one Courier's paperwork, at least one Courier signs at least one Authorized Person's paperwork and/or confirmation or affirmation of at least one other action.

Another step is depicted in FIG. 6 and could be at least one Notification received by Notification Parties 95 by at least one selected method of notification and can include but is not limited to: e-mail, text, phone and/or voice message, electronic data transmission, social network, internet, intranet, Ethernet, smart device transmission and or reception.

Another step is depicted in FIG. 6 and could be billing Authorized payer when required 96, and funds are then released to Company unless prepaid and/or on open account;

FIG. 7 is a flowchart diagram of the steps corresponding to sections A-E of claim 4 involving the Courier component, and from the Courier's interface with the Company and/or at least one Customer user, and this and can comprise at least one of the following steps:

Fulfillment Request received from a Dispatcher by at least one Courier 100 within an area that can potentially fulfill the Fulfillment Request in whole or in part can do at least one of the following: retrieve at least one Package from at least one Sender at at least one Pick-up location and/or Transfer location; deliver at least one Package to at least one Drop-off location and/or at least one other Transfer location; invoke and/or perform at least one intermediate value added operation including but not limited to Xeroxing, binding, collating, addressing, packaging, other clerical functions, filing papers in court, paying fees, getting filing receipts, and taking any at least one other action necessary; abide by the handling conditions of said Fulfillment Request, perform at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.

Another step is depicted in FIG. 7 and could be Fulfillment Request in whole or in part accepted 101.

Another step is depicted in FIG. 7 and could be Fulfillment Request assigned as a Job including disseminating instructions and supporting material and/or documentation 102, which can define at least one of the following functions: retrieving at least one Package from at least one Sender at at least one Pick-up location and/or Transfer location; delivering at least one Package to at least one Drop-off location and/or at least one other Transfer location; invoking and/or performing at least one intermediate value added operation including but not limited to Xeroxing, binding, collating, addressing, packaging, other clerical functions, filing papers in court, paying fees, getting filing receipts, and taking any at least one other action necessary; abiding by the handling conditions of said Job; and/or performing at least one of any other operation and/or function necessary to affect Job fulfillment and communication with the Company and/or at least one Authorized Person to define and/or redefine at least one of including but not limited to progress at at least one step in the fulfillment process, articulating any problems encountered, taking corrective action, affecting damage control, performing any other action necessary.

Another step is depicted in FIG. 7 and could be fulfillment of Job 103.

Another step is depicted in FIG. 7 and could be closing out transaction upon at least one Package delivery 104, which can includes at least one of the following: at least one Package delivery to at least one Drop-off location; securing at least one signature of at least one Authorized Person to confirm at least one Chain of custody proof; at least one Authorized Person informing Company that all order fulfillment functions have been successfully performed; and/or at least one Courier notification to Company that at least one Package has been delivered to at least one Drop-off location.

1. An application and/or program for communicating and interacting with human and/or machine components involved in at least one Package retrieval, transport, and delivery comprising at least one of the following steps:
1A) Download app (Company) and/or initiate app or initiate application from web-based program (website);
1B) Register and/or Sign-in to at least one of an application, web-based program, website, and/or other means comprising at least one of the following steps:
a) Filling in at least one profile data field;
b) Sign-in by entering at least one of: user name, password, at least one other sign-in request or requirement with or without auto fill and/or add to at least one menu (drop down or other);
1C) Service Request comprising at least one of the following steps:
a) Enter Order Placer information comprising at least one of the following:
i) Entering name or selecting from at least one menu with or without auto fill and/or adding to at least one menu;
ii) Entering at least one e-mail address and/or selecting from at least one menu with or without auto fill and/or adding to at least one menu;
iii) Entering at least one phone number and/or selecting from at least one menu with or without auto fill and/or adding to at least one menu;
iv) Entering other information that is at least one of screen name, additional phone number, additional e-mail address, customer code and/or account, other information that may be requested or required, and/or selecting from at least one menu with or without auto fill and/or adding to at least one menu;
v) Entering at least one amount of insurance necessary;
vi) Deleting at least one pre-existing data from at least one at least one menu.
b) Enter pick-up information comprising at least one of the following:
i) Entering at least one Authorized Person's name and/or selecting from at least one menu with or without auto fill and/or adding to at least one menu;
ii) Entering at least one Sender and/or Pick-up location and/or selecting from at least one menu with or without auto fill and/or adding to at least one menu;
iii) Enabling or disabling at least one Geo-location;
d) Entering at least one Sender and/or pick-up e-mail address and/or selecting from at least one menu with or without auto fill and/or adding to at least one menu;
iv) Entering at least one pick-up phone number and/or selecting from at least one menu with or without auto fill and/or adding to at least one menu;
v) Entering other and/or supplemental information that is at least one of screen name, additional phone number, additional e-mail address, customer code and/or account, other information that may be requested or required, and/or selecting from at least one menu with or without auto fill and/or adding to at least one menu;
vi) Entering at least one signature requirement;
vii) Entering at least one third Party acceptability;
viii) Deleting at least one pre-existing data from at least one at least one menu.
c) Enter at least one drop-off and/or Receiver information comprising at least one of the following:
i) Entering at least one Authorized Person's name and/or selecting from at least one menu with or without auto fill and/or adding to at least one menu;
ii) Entering at least one Receiver and/or Drop-off location and/or selecting from at least one menu with or without auto fill and/or adding to at least one menu;
iii) Enabling or disabling at least one Geo-location;
iv) Entering at least one Receiver and/or drop-off e-mail address and/or selecting from at least one menu with or without auto fill and/or adding to at least one menu;
v) Entering at least one Receiver and/or drop-off phone number and/or selecting from at least one menu with or without auto fill and/or adding to at least one menu;
vi) Entering other and/or supplemental information that is at least one of screen name, additional phone number, additional e-mail address, customer code and/or account, other information that may be requested or required, and/or selecting from at least one menu with or without auto fill and/or adding to at least one menu;
vii) Entering at least one signature requirement and who is at least one Authorized Person to sign for at least one Package and/or selecting from at least one menu with or without auto fill and/or adding to at least one menu;
viii) Entering at least one third Party acceptability to accept Package;
ix) Deleting at least one pre-existing data from at least one at least one menu.
1D) Schedule at least one pick-up time comprising specification of at least one of the following:
a) Choosing at least one time;
b) Choosing at least one level of urgency that comprises immediately and/or at least one delivery window of tolerance.
1E) Schedule at least one delivery time comprising specification of at least one of the following:
a) Choosing at least one time;
b) Choosing at least one level of urgency that comprises immediately and/or at least one delivery window of tolerance.
1F) Select at least one Courier service type comprising at least one of:
a) Selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting at least one previously stored selection;
b) Selecting at least one outside services employed using at least one of Fed Ex, UPS, US mail, Parcel post, other delivery service, don't care, selecting at least one previously stored selection and provide necessary information so said outside service can be invoked;
c) Deleting at least one pre-existing data from at least one at least one menu.
1G) Specify at least one Package contents comprising at least one of the following attributes:
a) At least one of liquid, solid, biological, living, animal, plant, chemical;
b) At least one of toxicity, explosive, dusty, foul and/or strange aroma;
c) At least one Package size;
d) At least one approximate weight;
e) At least one of at least one Package fragility, orientation to the vertical, specifying special handling instructions and/or free form notes, selecting at least one previously stored selection;
f) At least one other requested or required attribute and/or other data;
g) Deleting at least one pre-existing data from at least one at least one menu.
1H) Specification and/or special work description of at least one intermediate operation including but not limited to Xeroxing, binding, collating, addressing, packaging, other clerical functions, filing papers in court, paying fees, getting filing receipts, and taking any at least one other action necessary to effect delivery of at least one Package.
1I) Confirmation of data input before this step that comprises one of the choices:
Yes: =official submission of order then continue to Method of Payment;
No: re-enter data and confirmation of data re-entry.
1J) Choosing method of payment that is at least one of the following:
pre-paid;
open account;
credit card;
Paypal and/or other money on line services that can withdraw money directly from at least one of credit cards, debit cards, bank accounts;
wire transfer;
electronic transfer directly from bank account.
1K) Payment confirmation that is at least one of the following choices:
Yes: and continue to next step;
No: make another arrangement and return to Method of Payment (step 1J).
1L) Specifying notification including at least one of:
a) Specification of all Notification Parties Receiver confirmation of order is to be sent, which comprises at least one of at least one Order Placer, Sender, Receiver, at least one new customer and/or company, Authorized Person;
b) Confirmation of order for all said Notification Parties in L)a) to be notified in at least one of the following selectable methods of notification: e-mail, text, phone and/or voice message, electronic data transmission, social network, internet, intranet, Ethernet, smart device transmission and or reception.
1M) Company and Notification Parties receives confirmation of order in all specified methods of notification.
2A) Receiving Service Request via at least one of the web or a website, an app, e-mail, text, phone call and/or voice message, social media, instant message, encrypted or unencrypted instructions received in storage medium of any kind;
2B) Reformatting Service Request to fit at least one template.
2C) Devising at least one Package delivery fulfillment strategy including at least one of:
a) Short-distance delivery model comprising the same Courier picking up at least one Package at at least one Pick-up location and dropping off at least one Package at at least one Drop-off location employing walking and one other form of motorized or non-motorized transportation.
b) Mid-distance delivery model comprising the same Courier picking up at least one Package at at least one Pick-up location and dropping off at least one Package at at least one Drop-off location employing walking and multiple forms of motorized and/or non-motorized transportation which may or may not include public transportation.
c) Long-distance delivery model comprising the same or more than one Courier to provide Job fulfillment employing at least two of the following: walking, at least one form of motorized and/or non-motorized transportation, at least one type of public transportation, at least one carrier such as including but not limited to Fed Ex, UPS, US mail, Parcel post, other delivery service.
d) Invoking and/or performing at least one intermediate operation including but not limited to Xeroxing, binding, collating, addressing, packaging, other clerical functions, filing papers in court, paying fees, getting filing receipts, and taking any at least one other action necessary to effect delivery of at least one Package.
e) Performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.
2D) Fulfillment Request submitted by a Dispatcher to at least one Courier within an area who can potentially fulfill said Fulfillment Request in whole or in part.
2E) Response of at least one Courier via at least one means providing at least one of including but not limited to name and/or identifying information, location, availability, at least one method of transportation available, at least one skill set necessary to perform said at least one intermediate operation.
2F) Awarding the assignment for order fulfillment or a part thereof to at least one Courier, wherein the decision of which said at least one Courier is awarded the assignment for order fulfillment or a part thereof is made using at least one of the following criteria: first to respond, physical strength or other physical attribute, previous experience with special handling conditions of the type of Package to be delivered, mechanical aptitude, technical expertise, language skills, intelligence, professional demeanor, personal hygiene, reliability and/or punctuality, speed necessity of order fulfillment, mental health history, academic achievement, law enforcement experience, legal experience, military experience, special occupational experience, special licenses including but not limited to automobile, truck, motorcycle, boat, pilot, firearms, notary public in at least one state, at least one other criteria.
2G) Transportation fulfillment wherein at least one of the following occurs: at least one Courier takes custody of at least one Package at at least one Pick-up location, transports at least one Package to at least one Transfer location, picks up at least one Package from at least one Transfer location, delivers at least one Package to at least one Drop-off location, maintains at least one Chain of custody.
2H) Closing out transaction upon at least one Package delivery and includes at least one of the following:
a) Delivery of at least one Package to at least one Drop-off location;
b) Securing at least one signature of at least one Authorized Person to confirm at least one Chain of custody proof;
c) At least one Courier notification made to the Company informing that at least one Package has been delivered to at least one Drop-off location;
d) Company notifies Notification Parties by at least one selected method of notification including but not limited to: e-mail, text, phone and/or voice message, electronic data transmission, social network, internet, intranet, Ethernet, smart device transmission and or reception. (This notification may include at least one signature of at least one Authorized Person who signed for at least one Package at at least one Drop-off location.)
2I) Billing Authorized payer when required, and funds are then released to Company unless prepaid and/or on open account.
3A) Downloading app (from Company) and/or initiate or initiate application from web-based program (website);
3B) Register and/or Sign-in to at least one of an application, web-based program, website, and/or other means comprising at least one of the following steps:
a) Filling in at least one profile data field;
b) Sign-in by entering at least one of: user name, password, at least one other sign-in request or requirement with or without auto fill and/or adding to at least one menu.
3C) Entering Service Request comprising at least one of the following steps:
a) Entering Order Placer information comprising at least one of the following:
i) Entering name or selecting from at least one menu with or without auto fill and/or adding to at least one menu;
ii) Entering at least one e-mail address and/or selecting from at least one menu with or without auto fill and/or adding to at least one menu;
iii) Entering at least one phone number and/or selecting from at least one menu with or without auto fill and/or adding to at least one menu;
iv) Entering other information that is at least one of screen name, additional phone number, additional e-mail address, customer code or account, other information that may be requested or required, and/or selecting from at least one menu with or without auto fill and/or adding to at least one menu;
v) Entering at least one amount of insurance necessary;
vi) Deleting at least one pre-existing data from at least one at least one menu.
b) Entering at least one Pick-up and/or Sender set of information comprising at least one of the following:
i) Entering at least one Authorized Person's name and/or selecting from at least one menu with or without auto fill and/or adding to at least one menu;
ii) Entering at least one Sender and/or Pick-up location and/or selecting from at least one menu with or without auto fill and/or adding to at least one menu;
iii) Enabling or disabling at least one Geo-location;
iv) Entering at least one pick-up and/or Sender e-mail address and/or selecting from at least one menu with or without auto fill and/or adding to at least one menu;
v) Entering at lest one pick-up and/or Sender phone number and/or selecting from at least one menu with or without auto fill and/or adding to at least one menu;
vi) Entering other and/or supplemental information that is at least one of screen name, additional phone number, additional e-mail address, customer code and/or account, other information that may be requested or required, and/or selecting from at least one menu with or without auto fill and/or adding to at least one menu;
vii) Entering at least one signature requirement;
viii) Entering at least one third Party acceptability;
ix) Deleting at least one pre-existing data from at least one at least one menu.
c) Entering at least one drop-off and/or Receiver set of information comprising at least one of the following:
i) Entering at least one Authorized Person's name and/or selecting from at least one menu with or without auto fill and/or adding to at least one menu;
ii) Entering at least one Receiver and/or Drop-off location and/or selecting from at least one menu with or without auto fill and/or adding to at least one menu;
iii) Enabling or disabling at least one Geo-location;
iv) Entering at least one Receiver and/or drop-off e-mail address and/or selecting from at least one menu with or without auto fill and/or adding to at least one menu;
v) Entering at least one Receiver and/or drop-off phone number and/or selecting from at least one menu with or without auto fill and/or adding to at least one menu;
vi) Entering other and/or supplemental information that is at least one of screen name, additional phone number, additional e-mail address, customer code and/or account, other information that may be requested or required, and/or selecting from at least one menu with or without auto fill and/or adding to at least one menu;
vii) Entering at least one signature requirement and who is at least one Authorized Person to sign for at least one Package and/or selecting from at least one menu with or without auto fill and/or adding to at least one menu;
viii) Entering at least one third Party acceptability to accept at least one Package;
ix) Deleting at least one pre-existing data from at least one at least one menu.
3D) Scheduling at least one pick-up time comprising specification of at least one of the following:
a) Choosing at least one time;
b) Choosing at least one level of urgency that comprises immediately and/or at least one delivery window of tolerance.
3E) Scheduling at least one delivery time comprising specification of at least one of the following:
a) Choosing at least one the time;
b) Choosing at least one level of urgency that comprises immediately and/or at least one delivery window of tolerance.
3F) Selecting at least one Courier service type comprising at least one of:
a) Selecting at least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting previously stored selections;
b) Selecting at least one outside services employed using at least one of Fed Ex, UPS, US mail, Parcel post, other delivery service, don't care, selecting at least one previously stored selection and provide necessary information so said outside service can be invoked;
c) Deleting at least one pre-existing data from at least one at least one menu.
3G) Specifying at least one Package contents comprising at least one of the following attributes:
a) At least one of liquid, solid, biological, living, animal, plant, chemical;
b) At least one of toxicity, explosive, dusty, foul and/or strange aroma;
c) At least one Package size;
d) At least one approximate weight;
e) At least one of at least one Package fragility, orientation to the vertical, at least one special handling instruction and/or free form notes, selecting at least one previously stored selection;
f) At least one other requested or required attribute and/or other data;
g) Deleting at least one pre-existing data from at least one at least one menu.
3H) Specification and/or special work description of at least one intermediate operation including but not limited to Xeroxing, binding, collating, addressing, packaging, other clerical functions, filing papers in court, paying fees, getting filing receipts, and taking any at least one other action necessary to effect delivery of at least one Package.
3I) Confirmation of data input before this step that comprises one of the choices:
Yes: =official submission of order then continue to Method of Payment;
No: re-enter data and confirmation of data re-entry.
3J) Choosing method of payment that is at least one of the following:
pre-paid;
open account;
credit card;
Paypal and/or other money on line services that can withdraw money directly from at least one of credit cards, debit cards, bank accounts;
wire transfer;
electronic transfer directly from bank account.
3K) Payment confirmation that is at least one of the following choices:
Yes: and continue to next step;
No: make another arrangement and return to method of payment (step 3J).
3L) Specifying notification including at least one of:
a) Specification of all Notification Parties Receiver confirmation of order is to be sent, which comprises at least one of at least one Order Placer, Sender, Receiver, at least one new customer and/or company, Authorized Person;
b) Confirmation of order for all said Notification Parties in 3L)a) to be notified in at least one of the following selectable methods of notification: e-mail, text, phone and/or voice message, electronic data transmission, social network, internet, intranet, Ethernet, smart device transmission and or reception.
3M) Notification Parties receives confirmation of order in specified methods of notification;
3N) At least one of at least one Courier arrives at at least one Sender's Pick-up location at at least one designated time, at least one Authorized Person gives at least one Package to at least one Courier, at least one Authorized Person signs at least one Courier's paperwork, at least one Courier signs at least one Authorized Person's paperwork;
3O) At least one of at least one Courier arrives at at least one Receiver's Drop-off location at at least one designated time, at least one Authorized Person receives at least one Package from at least one Courier, at least one Authorized Person signs at least one Courier's paperwork, at least one Courier signs at least one Authorized Person's paperwork and/or confirmation or affirmation of at least one other action;
3P) At least one Notification received by Notification Parties by at least one selected method of notification including but not limited to: e-mail, text, phone and/or voice message, electronic data transmission, social network, internet, intranet, Ethernet, smart device transmission and or reception;
3Q) Billing Authorized payer when required, and funds are then released to Company unless prepaid and/or on open account.
4A) Fulfillment Request received from a Dispatcher by at least one Courier within an area that can potentially fulfill said Fulfillment Request in whole or in part to do at least one of the following:
a) Retrieve at least one Package from at least one Sender at at least one Pick-up location and/or Transfer location;
b) Deliver at least one Package to at least one Drop-off location and/or at least one other Transfer location;
c) Invoke and/or perform at least one intermediate value added operation including but not limited to Xeroxing, binding, collating, addressing, packaging, other clerical functions, filing papers in court, paying fees, getting filing receipts, and taking any at least one other action necessary;
d) Abide by the handling conditions of said Fulfillment Request;
e) Perform at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.
4B) Fulfillment Request in whole or in part accepted;
4C) Fulfillment Request assigned as a Job including disseminating instructions and supporting material and/or documentation defining at least one of the following functions:
a) Retrieving at least one Package from at least one Sender at at least one Pick-up location and/or Transfer location;
b) Delivering at least one Package to at least one Drop-off location and/or at least one other Transfer location;
c) Invoking and/or performing at least one intermediate value added operation including but not limited to Xeroxing, binding, collating, addressing, packaging, other clerical functions, filing papers in court, paying fees, getting filing receipts, and taking any at least one other action necessary;
d) Abiding by the handling conditions of said Job;
e) Performing at least one of any other operation and/or function necessary to affect Job fulfillment and communication with the Company and/or at least one Authorized Person to define and/or redefine at least one of including but not limited to progress at at least one step in the fulfillment process, articulating any problems encountered, taking corrective action, affecting damage control, performing any other action necessary.
4D) Fulfillment of Job;
4E) Closing out transaction upon at least one Package delivery and includes at least one of the following:
a) at least one Package delivery to at least one Drop-off location;
b) Securing at least one signature of at least one Authorized Person to confirm at least one Chain of custody proof;
c) at least one Authorized Person informing Company that all order fulfillment functions have been successfully performed;
d) at least one Courier notification to Company that at least one Package has been delivered to at least one Drop-off location.

2. An application and/or program for communicating and interacting with human and/or machine components involved in at least one Package retrieval, transport, and delivery comprising at least one of the following steps:
A) Receive Service Request via at least one of the web or a website, an app, e-mail, text, phone call and/or voice message, social media, instant message, encrypted or unencrypted instructions received in storage medium of any kind;
B) Reformat Service Request is to fit at least one template.
C) Devise at least one Package Job fulfillment strategy including at least one of the following function definitions:
a) Short-distance delivery model comprising the same Courier picking up at least one Package at at least one Pick-up location and dropping off at least one Package at at least one Drop-off location employing walking and one other form of motorized or non-motorized transportation;
b) Mid-distance delivery model comprising the same Courier picking up at least one Package at at least one Pick-up location and dropping off at least one Package at at least one Drop-off location employing walking and multiple forms of motorized and/or non-motorized transportation which may or may not include public transportation;
c) Long-distance delivery model comprising the same or more than one Courier to provide Job fulfillment employing at least two of the following: walking, at least one form of motorized and/or non-motorized transportation, at least one type of public transportation, at least one carrier such as including but not limited to Fed Ex, UPS, US mail, Parcel post, other delivery service;
d) Invoking and/or performing at least one intermediate operation including but not limited to Xeroxing, binding, collating, addressing, packaging, other clerical functions, filing papers in court, paying fees, getting filing receipts, and taking any at least one other action necessary to effect delivery of at least one Package.
D) Fulfillment Request submitted by a Dispatcher to at least one Courier within an area who can potentially fulfill said Fulfillment Request in whole or in part.
E) Response by at least one Courier via at least one means providing at least one of including but not limited to name and/or identifying information, location, availability, at least one method of transportation available, at least one skill set necessary to perform said at least one intermediate operation.
F) Awarding the assignment for order fulfillment or a part thereof to at least one Courier, wherein the decision of which said at least one Courier is awarded the assignment for order fulfillment or a part thereof is made using at least one of the following criteria: first to respond, physical strength or other physical attribute, previous experience with special handling conditions of the type of Package or Packages to be delivered, mechanical aptitude, technical expertise, language skills, intelligence, professional demeanor, personal hygiene, reliability and/or punctuality, speed necessity of order fulfillment, mental health history, academic achievement, law enforcement experience, legal experience, military experience, special occupational experience, special licenses including but not limited to automobile, truck, motorcycle, boat, pilot, firearms, notary public in at least one state, at least one other criteria.
G) Transportation fulfillment wherein at least one of the following occurs: at least one Courier takes custody of at least one Package at at least one Pick-up location, transports at least one Package to at least one Transfer location, picks up at least one Package from at least one Transfer location, delivers at least one Package to at least one Drop-off location, maintains at least one Chain of custody.
H) Closing out transaction upon at least one Package delivery and includes at least one of the following:
a) Delivery of at least one Package to at least one Drop-off location;
b) Securing at least one signature of at least one Authorized Person to confirm at least one Chain of custody proof;
c) At least one Courier notification made to the Company informing that at least one Package has been delivered to at least one Drop-off location;
d) Company notifies Notification Parties by at least one selected method of notification including but not limited to: e-mail, text, phone and/or voice message, electronic data transmission, social network, internet, intranet, Ethernet, smart device transmission and or reception. (This notification may include at least one signature of at least one Authorized Person who signed for at least one Package at at least one Drop-off location.)
I) Billing Authorized payer when required, and funds are then released to Company unless prepaid and/or on open account.

3. An application and/or program for communicating and interacting with the Company comprising at least one of the following steps:
A) Downloading app (from Company) and/or initiating or initiating application from web-based program (website).
B) Register and/or Sign-in to at least one of an application, web-based program, website, and/or other means comprising at least one of the following steps:
a) Filling in at least one profile data field;
b) Sign-in by entering at least one of: user name, password, at least one other sign-in request or requirement with or without auto fill and/or add to at least one menu.
C) Entering Service Request comprising at least one of the following steps:
a) Entering Order Placer information comprising at least one of the following:
i) Entering name or selecting from at least one menu with or without auto fill and/or adding to at least one menu;
ii) Entering at least one e-mail address and/or selecting from at least one menu with or without auto fill and/or adding to at least one menu;
iii) Entering at least one phone number and/or selecting from at least one menu with or without auto fill and/or adding to at least one menu;
iv) Entering other information that is at least one of screen name, additional phone number, additional e-mail address, customer code or account, other information that may be requested or required, and/or selecting from at least one menu with or without auto fill and/or adding to at least one menu;
v) Entering at least one amount of insurance necessary;
vi) Deleting at least one pre-existing data from at least one at least one menu.
b) Entering at least one pick-up and/or Sender set of information comprising at least one of the following:
i) Entering at least one Authorized Person's name and/or selecting from at least one menu with or without auto fill and/or adding to at least one menu;
ii) Entering at least one Sender and/or Pick-up location and/or selecting from at least one menu with or without auto fill and/or adding to at least one menu;
iii) Enabling or disabling at least one Geo-location;
iv) Entering at least one pick-up and/or Sender e-mail address and/or selecting from at least one menu with or without auto fill and/or adding to at least one menu;
v) Entering at lest one pick-up and/or Sender phone number and/or selecting from at least one menu with or without auto fill and/or adding to at least one menu;
vi) Entering other and/or supplemental information that is at least one of screen name, additional phone number, additional e-mail address, customer code and/or account, other information that may be requested or required, and/or selecting from at least one menu with or without auto fill and/or adding to at least one menu;
vii) Entering at least one signature requirement;
viii) Entering at least one third Party acceptability;
ix) Deleting at least one pre-existing data from at least one at least one menu.
c) Entering at least one drop-off and/or Receiver set of information comprising at least one of the following:
i) Entering at least one Authorized Person's name and/or selecting from at least one menu with or without auto fill and/or adding to at least one menu;
ii) Entering at least one Receiver and/or Drop-off location and/or selecting from at least one menu with or without auto fill and/or adding to at least one menu;
iii) Enabling or disabling at least one Geo-location;
iv) Entering at least one Receiver and/or drop-off e-mail address and/or selecting from at least one menu with or without auto fill and/or adding to at least one menu;
v) Entering at least one Receiver and/or drop-off phone number and/or selecting from at least one menu with or without auto fill and/or adding to at least one menu;
vi) Entering other and/or supplemental information that is at least one of screen name, additional phone number, additional e-mail address, customer code and/or account, other information that may be requested or required, and/or selecting from at least one menu with or without auto fill and/or adding to at least one menu;
vii) Entering at least one signature requirement and who is at least one Authorized Person to sign for at least one Package and/or selecting from at least one menu with or without auto fill and/or adding to at least one menu;
viii) Entering at least one third Party acceptability to accept at least one Package;
ix) Deleting at least one pre-existing data from at least one at least one menu.
D) Schedule at least one pick-up time comprising specification of at least one of the following:
a) Choosing at least one time;
b) Choosing at least one level of urgency that comprises immediately and/or at least one delivery window of tolerance.
E) Schedule at least one delivery time comprising specification of at least one of the following:
a) Choosing at least one the time;
b) Choosing at least one level of urgency that comprises immediately and/or at least one delivery window of tolerance.
F) Select at least one Courier service type comprising at least one of:
a) At least one method of transportation using and/or not using at least one of walking, bicycle, skateboard, powered or unpowered scooter, skiing, motorcycle, car, bus, cab, truck, train, trolley, ferry, boat, airplane and/or flying machine, snowmobile, horse, drone, robotic delivery system, other means of transportation now known or unknown, don't care, selecting previously stored selections;
b) At least one outside services employed using at least one of Fed Ex, UPS, US mail, Parcel post, other delivery service, don't care, selecting at least one previously stored selection and provide necessary information so said outside service can be invoked.
c) Deleting at least one pre-existing data from at least one at least one menu.
G) Specify at least one Package contents comprising at least one of the following attributes:
a) At least one of liquid, solid, biological, living, animal, plant, chemical;
b) At least one of toxicity, explosive, dusty, foul and/or strange aroma;
c) At least one Package size;
d) At least one approximate weight;
e) At least one of at least one Package fragility, orientation to the vertical, at least one special handling instruction and/or free form notes, selecting at least one previously stored selection;
f) At least one other requested or required attribute and/or other data;
g) Deleting at least one pre-existing data from at least one at least one menu.
H) Specification and/or special work description of at least one intermediate operation including but not limited to Xeroxing, binding, collating, addressing, packaging, other clerical functions, filing papers in court, paying fees, getting filing receipts, and taking any at least one other action necessary to effect delivery of at least one Package.
I) Confirmation of data input before this step that comprises one of the choices:
Yes: =official submission of order then continue to Method of Payment;
No: re-enter data and confirmation of data re-entry.
J) Choosing method of payment that is at least one of the following:
pre-paid;
open account;
credit card;
Paypal and/or other money on line services that can withdraw money directly from at least one of credit cards, debit cards, bank accounts;
wire transfer;
electronic transfer directly from bank account.
K) Payment confirmation that is at least one of the following choices:
Yes: and continue to next step;
No: make another arrangement and return to Method of Payment (step J)
L) Specifying notification including at least one of:
a) Specification of all Notification Parties Receiver confirmation of order is to be sent, which comprises at least one of at least one Order Placer, Sender, Receiver, at least one new customer and/or company, Authorized Person;
b) Confirmation of order for all said Notification Parties in L)a) to be notified in at least one of the following selectable methods of notification: e-mail, text, phone and/or voice message, electronic data transmission, social network, internet, intranet, Ethernet, smart device transmission and or reception.
M) Notification Parties receives confirmation of order in specified methods of notification.
N) At least one of at least one Courier arrives at at least one Sender's Pick-up location at at least one designated time, at least one Authorized Person gives at least one Package to at least one Courier, at least one Authorized Person signs at least one Courier's paperwork, at least one Courier signs at least one Authorized Person's paperwork.
O) At least one of at least one Courier arrives at at least one Receiver's Drop-off location at at least one designated time, at least one Authorized Person receives at least one Package from at least one Courier, at least one Authorized Person signs at least one Courier's paperwork, at least one Courier signs at least one Authorized Person's paperwork and/or confirmation or affirmation of at least one other action.
P) Notification received by Notification Parties by at least one selected method of notification including but not limited to: e-mail, text, phone and/or voice message, electronic data transmission, social network, internet, intranet, Ethernet, smart device transmission and or reception.
Q) Billing Authorized payer when required, funds are then released to Company unless prepaid and/or on open account.

4. An application and/or program for communicating and interacting with at least one Courier and/or machine components involved in at least one Package retrieval, transport, and delivery comprising at least one of the following steps:
A) Fulfillment Request received from a Dispatcher by at least one Courier within an area that can potentially fulfill said Fulfillment Request in whole or in part to do at least one of the following:
a) Retrieving at least one Package from at least one Sender at at least one Pick-up location and/or Transfer location;
b) Delivering at least one Package to at least one Drop-off location and/or at least one other Transfer location;
c) Invoking and/or performing at least one intermediate value added operation including but not limited to Xeroxing, binding, collating, addressing, packaging, other clerical functions, filing papers in court, paying fees, getting filing receipts, and taking any at least one other action necessary;
d) Abiding by the handling conditions of said Fulfillment Request;
e) Performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.
B) Fulfillment Request in whole or in part accepted;
C) Fulfillment Request assigned as a Job including disseminating instructions and supporting material and/or documentation defining at least one of the following functions:
a) Retrieving at least one Package from at least one Sender at at least one Pick-up location and/or Transfer location;
b) Delivering at least one Package to at least one Drop-off location and/or at least one other Transfer location;
c) Invoking and/or performing at least one intermediate value added operation including but not limited to Xeroxing, binding, collating, addressing, packaging, other clerical functions, filing papers in court, paying fees, getting filing receipts, and taking any at least one other action necessary;
d) Abiding by the handling conditions of said Job;
e) Performing at least one of any other operation and/or function necessary to affect fulfillment and communication with the Company and/or any Authorized Person to define and/or redefine at least one of including but not limited to progress at at least one step in the fulfillment process, articulating any problems encountered, taking corrective action, affecting damage control, taking any other action necessary.
D) Fulfillment of Job;
E) Closing out transaction upon at least one Package delivery and includes at least one of the following:
a) At least one Package delivery to at least one Drop-off location;
b) Securing at least one signature of at least one Authorized Person to confirm at least one Chain of custody proof;
c) At least one Authorized Person informing the Company that all order fulfillment functions have been successfully performed;
d) At least one Courier notification to the Company that at least one Package has been delivered to at least one Drop-off location.
